(19) United States
(12) Patent Application Publication
(10) Pub. No.: US 2012/0088477 A1
(43) Pub. Date: Apr. 12, 2012

(54) MOBILE HANDSET FOR MEDIA ACCESS AND PLAYBACK

(75) Inventor: Brendon P. Cassidy, Los Angeles, CA (US)

(73) Assignee: CRICKET COMMUNICATIONS, INC.

(21) Appl. No.: 13/158,300

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/425,192, filed on Dec. 20, 2010.

(51) Int. Cl. H04W 4/00

(52) U.S. Cl. 455/414.1

(57) ABSTRACT

Methods, systems, and apparatus are presented for accessing unlimited media service from a mobile communications device. A media server environment can be provided, which maintains an instance of each subscriber account and a central archive of media content. Further, the central archive can be explored through the use of a media application executed on a mobile communications device to select media content, including individual items of media content, playlists, ringtones, and ringback tones. The selected media content can be downloaded to, and stored locally at, the mobile communications device, such as on a secure storage device. Additionally, media content corresponding to a subscribed playlist can be automatically updated at the mobile communications device in response to changes to the playlist.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, and to Provisional Patent Application No. 61/394,222 entitled “Media Server Providing Unlimited Media Access Over Wireless Infrastructure” filed Oct. 18, 2010, the contents of all three of which are incorporated herein by reference.

### TECHNICAL FIELD

The present disclosure relates to providing unlimited access to media, such as music and ring tones, to a mobile handset over wireless infrastructure, and to managing the unlimited access to media, local storage of accessed media, and local playback of media from the mobile handset.

### BACKGROUND

Mobile communications devices have been adapted to a wide variety of applications, including computing, communication, and entertainment. For example, mobile communications devices permit users to freely initiate and receive voice communications, e.g. through dial-up connections or push-to-talk. Further, mobile communications devices have been developed to provide users with access to data communications through wireless connectivity, such as over Institute of Electrical and Electronic Engineers (IEEE) 802.11 or 3G/4G networks. Data communications can provide a user with access to a wide variety of entertainment options, including audio, video, and gaming content.

Services have been developed which permit a user to load media content, e.g. music and videos, onto a mobile communications device for subsequent playback. For instance, media content can be purchased from an on-line source, such as in accordance with a pay-per-song model. Purchased media content can be downloaded to a computing device, such a desktop or a laptop. Further, the content can be transferred off-line to from the computing device to a mobile communications device, e.g. through a sync (or synchronization) procedure. The media content can then be played back on the mobile communications device using a playback application. Once the media content is no longer desired on the mobile communications device, it can be deleted. If the media content is deleted, either purposefully or inadvertently, or if the mobile device is lost, the media content must be repurchased if it is once again desired. Accordingly, media device functionality, e.g. an MP3 player, can be incorporated into a mobile communications device.

Internet radio (or web radio or streaming radio) also has been developed to stream music over a network, such as the internet, to receivers that can play the streamed content. Internet radio typically is implemented similar to traditional broadcast radio in that the streamed content cannot be paused or replayed. Further, channels can be programmed to feature a particular style, type, or genre of content, but cannot be programmed by the listener. Additionally, the streamed content is not persistently stored on the receiver, so play back is possible only when a connection to the streaming source is available.

### SUMMARY

A mobile communications device (or “handset”) can be configured to operate in conjunction with a service structured to provide a subscriber with unlimited access to and/or unlimited use of media content. Unlimited access and/or unlimited use can be truly unlimited, such that no restrictions are placed on the amount of media that can be downloaded in a given period, e.g. a week or a month. Alternatively, unlimited access and/or unlimited use can be structured to impose one or more restrictions, such as a limitation on network traffic, e.g. measured in megabytes or gigabytes, over a given period, e.g. an hour or a day. The media content can include one or more of audio content, e.g. music, and video content, e.g. music videos. Other types of media content, e.g. movies, television programs, and shorts, also can be provided. Additionally, media content structured for use in communications, e.g. ring tones and ring back tones, also can be accessed by the mobile communications device.

Unlimited access to media content also can be provided in conjunction with one or more communications services, including one or more of voice communications, text communications, and data communications. The mobile communications device can be adapted to provide access both to the media content and to the communications services. For instance, the mobile communications device can be associated with a subscription to a single, unlimited-use offering that includes access to media content and one or more communications services.

The present inventors recognized a need to provide a mobile communications device configured to provide access to a local media archive and a remote media archive. The need to permit using the mobile communications device to select media, such as one or more songs, for download from the remote media archive to the local media archive also was recognized. Further, the present inventors recognized the need to permit adding one or more items of media to a play queue or a play list for local playback on the mobile communications device. The need to augment or revise a play queue or play list, including during playback, also was recognized. Additionally, the present inventors recognized the need to provide random playback from a local media archive, wherein media is selected for playback in accordance with one or more metrics associated with subscriber playback history.

The present inventors also recognized the need to permit switching the interface presented by the mobile communications device directly from a view of a media item included in the local media archive to a corresponding view of the media item in the remote media archive. Also, the need to perform digital rights management (DRM) at the storage media level for the local music archive was recognized. Further, the need to provide a secure, removable storage medium, e.g. a memory card, on which the local media archive can be stored also was recognized.

The techniques described in this specification can be implemented to realize one or more of the following advantages. The techniques can be implemented such that a mobile communications device can store locally an archive of media based on a subscription plan instead of a pay-per-download model. The techniques also can be implemented to permit authorizing a user to access media on the mobile communications device based on having an active subscription. Further, the techniques can be implemented to permit automatically altering one or more items of media stored on the mobile communications device based on one or more play lists. For instance, a play list can be altered periodically, e.g. weekly, and music included in the play list that is not presently stored on the mobile communications device can be automatically downloaded to the mobile communications device.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows an exemplary computing environment in which media can be transferred to a mobile communications device.

FIG. 2 shows an exemplary mobile communications device.

FIG. 3 shows an exemplary data flow between a mobile communications device, a computing device, and a server.

FIG. 4 shows exemplary media interfaces associated with a media application that can be presented by a mobile communications device.

FIG. 5. shows exemplary interfaces associated with play queue management that can be presented by a mobile communications device.

FIG. 6 shows exemplary interfaces associated with playlist creation and management that can be presented by a mobile communications device.

FIG. 7 shows exemplary playlist management interfaces corresponding to a variety of functional areas.

FIG. 8 shows an exemplary process flow for play queue management.

FIG. 9 shows an exemplary process flow for playlist management.

FIGS. 10A and B show exemplary navigation interfaces associated with the media application.

FIG. 11 shows an exemplary interface for performing functions relating to a media item in the unlimited media system.

FIGS. 12A-12C show exemplary interfaces for controlling the playback of media.

FIGS. 13A and 13B show exemplary interfaces relating to playlist functionality in the media application.

FIG. 14 shows exemplary media application interfaces for receiving suggestions.

FIG. 15 shows exemplary interfaces associated with a setup wizard of the media application.

FIG. 16 illustrates an example of accessing related media content in a remote media archive based on an item of media content stored in a local media archive.

FIGS. 17A and B show exemplary media application interfaces for accessing the remote media archive.

FIG. 18 shows exemplary media application interfaces for generating a message in the media application.

FIGS. 19A and B show exemplary media application interfaces for social interaction in the media application

Like reference symbols indicate like elements throughout the specification and drawings. Additional figures also are shown in the attached appendix.

### DETAILED DESCRIPTION

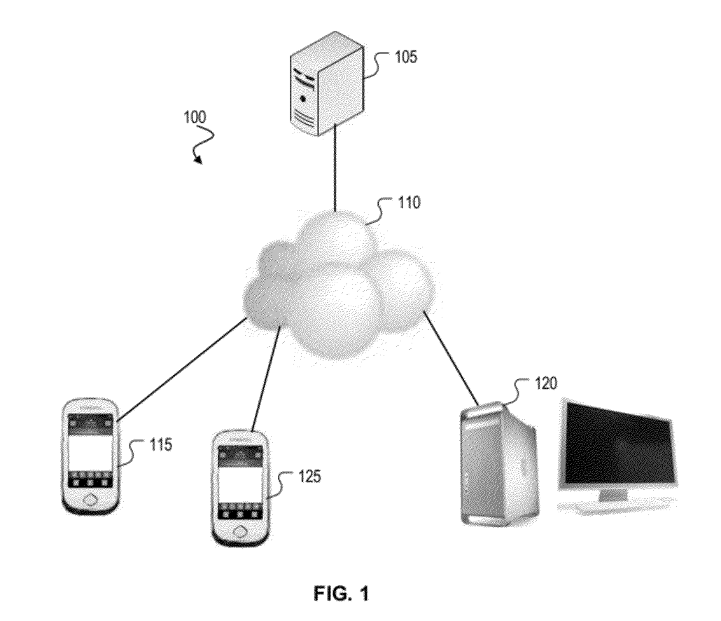

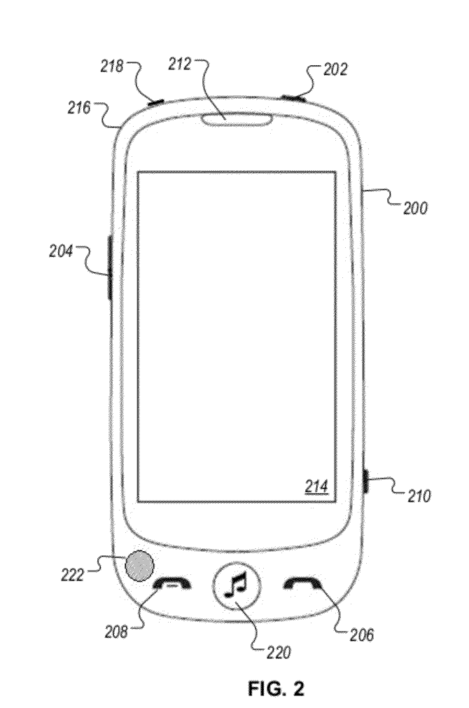

FIG. 1 shows an exemplary computing environment in which media can be transferred to a mobile communications device. Computing environment 100 can include a server 105 (or “the cloud”) configured to provide access to and management of media content. Server 105 can be implemented using a single computing device or multiple computing devices, which can be co-located or distributed across two or more locations. For instance, in some implementations, server 105 can be implemented using one or more application servers, web servers, and data servers, which can be housed in one or more locations.

Server 105 can host one or more applications configured to manage subscribing users. For instance, server 105 can be configured to validate a mobile communications device before the device is authorized to perform media related functions, including accessing locally stored media and downloading media from server 105. Further, server 105 can maintain an instance of one or more user accounts, including user account details, e.g. mobile identification number and subscriber name, locally stored music, subscribed play lists, managed play lists, play back history, and contacts. Server 105 also can host a media catalog (or media archive), which can be accessed through a subscribing mobile communications device in order to select media for download to the mobile communications device. Additionally, server 105 can be configured to manage the transfer of music to one or more subscribing mobile communications devices, including the transfer of specifically requested media and the automated transfer of media based on a subscription, e.g. to a play list.

Server 105 can be adapted to communicate with subscribing users over a network 110, which can be implemented using one or more data networks. For instance, network 110 can include either or both of wired and wireless communication links. Further, network 110 can be a public network, e.g. the internet, a private network, e.g. a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g. roaming partners.

Mobile communications device 115, which is associated with a subscribing user, also can be configured to communicate over network 110, e.g. with server 105 and with other mobile communications devices 125. For example, a transmitter, a receiver or a combined transceiver can be included to provide the means to communication over the network 110. In addition, the mobile communication device can include a baseband processor to control various operations of the mobile communication device. In some implementations, the other mobile communications devices 125 need not be associated with other subscribing users. Any number of mobile communications devices 115 can be included in computing environment 100. As the number of mobile communications devices 115 increases, server 105 and network 110 can be scaled, e.g. by adding additional resources, to provide an acceptable level of service. A mobile communications device 115 can be any mobile device configured to communicate over the network 110 with a host service provider, e.g. server 105. For instance, a mobile communications device 115 can be a mobile telephone that is adapted to transmit and receive data communications, e.g., a smart phone, a personal digital assistant, a tablet computing device, a mini-computer, a micro-computer, a notebook computer, a laptop, or any other such computing device.

A mobile communications device 115 further can include a data storage device configured to receive and store media content. The data storage device can be adapted to provide secure storage for the media content, as well as to perform digital rights management functions, e.g. decrypting media content for playback on the mobile communications device 115. In some implementations, the data storage device can be a removable device, e.g. a flash memory module. Thus, a local media library can be stored across multiple data storage devices, which can be swapped to provide access to different portions of the library.

A mobile communications device 115 also can include a display, e.g. a liquid crystal display (LCD) or a light emitting diode (LED) display, and one or more user input devices, such as a touch screen (resistive or capacitive), a touch pad, one or more buttons, one or more keys, a scroll wheel, a dial, a switch, a microphone, or any other such input device. Further, a mobile communications device 115 can be adapted to communicate using one or more protocols, such as 3G, Wi-Fi, or other such protocols. For instance, a mobile communications device 115 can be configured to communicate over Wi-Fi when possible and otherwise to use a 3G connection.

Additionally, computing environment 100 can include one or more computing systems 120. A computing system 120 can be implemented using an computing device, such as a desktop computer, a laptop computer, a notebook computer, a net book, a tablet computing device, a workstation, and a server. Computing system 120 also can be configured to transmit and receive data over network 110, e.g. over a TCP/IP connection. Thus, computing system 120 can be adapted to provide data communications with server 105. For instance, computing system 120 can be used to perform functions relating to a subscribing user's account, such as account management and the selection of media.

FIG. 2 shows an exemplary mobile communications device. Mobile communications device 200 can be configured to provide wireless voice communication and data communication. The device 200 can include physical controls, e.g. a power button 202, a volume control 204, a phone button 206, an end call button 208, and a camera button 210. Further, the device 200 can include outputs, such as speaker 212 and display 214, which can be a touch sensitive display, e.g. resistive or capacitive. Display 214 can be configured to sense either or both of simple gestures and complex gestures, such as multi-touch gestures. In some implementations, the device 200 also can include one or more additional speakers 216 to provide for additional audio output. The one or more speakers can be located on any or all of the peripheral edges, the back, and the front of the device 200. One or more of the included speakers, e.g. the one or more speakers 216, can be used to implement audio playback and/or speakerphone functionality. An accessory jack 218, e.g. for headphones, also can be included. Further, the device 200 can have an integrated digital signal processor (DSP) that can provide for customized tuning of audio output. For example, the DSP can be adapted to provide a graphic equalizer, e.g. a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g. a home menu, to be presented. The device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause the music player interface to be displayed, while pressing and holding can cause the home screen of the remote media catalog (or store) to be displayed. The device 200 also can include physical controls for other functions, including volume and traversing back in the interface.

Also, in some implementations, a back button 222 can be included on the device 200. For implementations in which a back button 222 is included, the corresponding functionality can be removed from one or more interfaces presented on the device 200. For instance, one or more interfaces, e.g. associated with a media application, can include a virtual (or “soft”) command button or other such icon that can be selected to navigate backward within the interface hierarchy, such as to a preceding interface screen. When the back button 222 is included as a physical control on the device 200, it can be selected to perform the navigation function associated with the virtual command button, e.g. returning to a preceding interface screen, and the virtual command button can be removed to simplify the interface. In some other implementations, physical and virtual command buttons can be provided for one or more functions, including navigation.

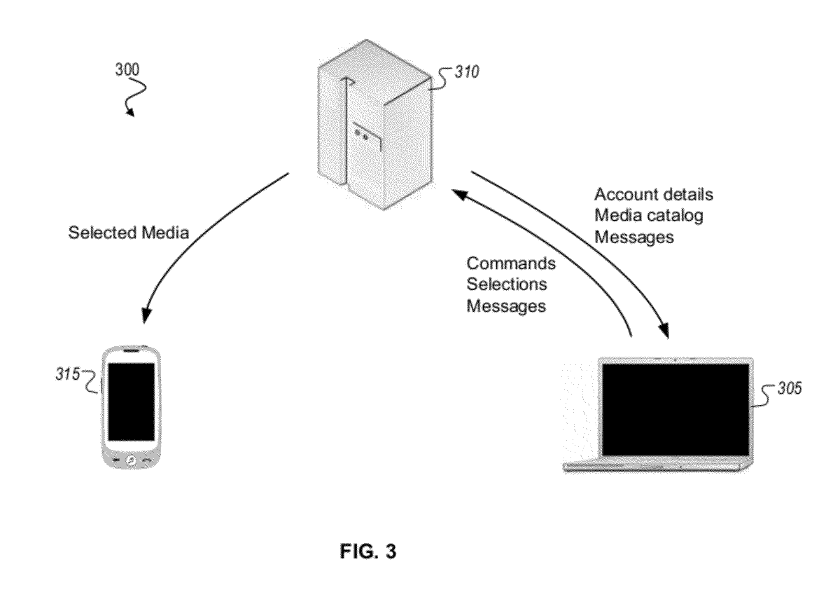

FIG. 3 shows an exemplary data flow between a mobile communications device, a computing device, and a server. Computing environment 300 can include a computing device 305, a server 310, and a mobile communications device 315. Computing device 305 can be implemented using any computer, including a desktop computer, a laptop computer, a net book, a tablet computer, a workstation, and a server. Further, server 310 can be implemented using one or more servers, e.g. as a combination of servers forming a virtual server, including one or more application servers, data servers, and web servers. Additionally, mobile communications device 315 can be any communication device configured to provide data communications, e.g. a smart phone or web-enabled phone.

Server 310 can communicate separately with both computing device 305 and mobile communications device 315. For instance, server 310 can communicate with computing device 305 over a public network, e.g. the internet, a private network, e.g. a local area network (LAN), or a combination thereof. Further, server 310 can communicate with mobile communications device 315 over a network that includes a wireless data network link, e.g. to a 3G or 4G network. Further, computing device 305 can communicate with mobile communications device 315 via a communications network, e.g., via a Wi-Fi or a 3G or 4G network. In some implementations, computing device 305 and mobile communications device 315 can be configured such that they do not communicate directly with each other.

Computing device 305 can communicate with server 310 to perform operations relating to one or more hosted media applications. For instance, computing device 305 can perform account management functions, messaging, and play list management. Server 310 can provide one or more interfaces to computing device 305. In some implementations, the one or more interfaces can be formatted for a larger display and thus can include additional information. Additionally, the one or more interfaces can be presented without installing an application or plug-in, e.g. as web pages presented in a browser. The interfaces can be compatible with multiple browsers, such that subscriber management from the computing device 305 can be platform independent.

The interfaces provided by server 310 can enable access to account details relating to a subscribing user, e.g. address and subscription information. Further, server 310 can provide access to at least a portion of a media collection, including one or more play lists. Items of media content can be selected from the media collection for download. Also, play lists can be managed, including generating play lists, modifying play lists, deleting play lists, subscribing to play lists and unsubscribing from play lists. Additionally, server 310 can provide access to messaging associated with a media application, including the ability to read messages that have been received and to generate new messages.

Server 310 further can be configured to transfer media content selected through computing device 305 directly to mobile communications device 315. For instance, a user can browse the media collection provided by server 310 through an interface provided by computing device 305, and can select one or more items of media content, e.g. songs, for download. The items of media content selected for download can be transferred, e.g. through an over-the-air download, directly to mobile communications device 315. As a result, mobile communications device 315 need not be synchronized with, or otherwise communicate with, computing device 305. Also, media content need not be downloaded to or stored on computing device 305. Thus, shared computing devices, e.g. library or school computers, can be used to perform account management and media management functions.

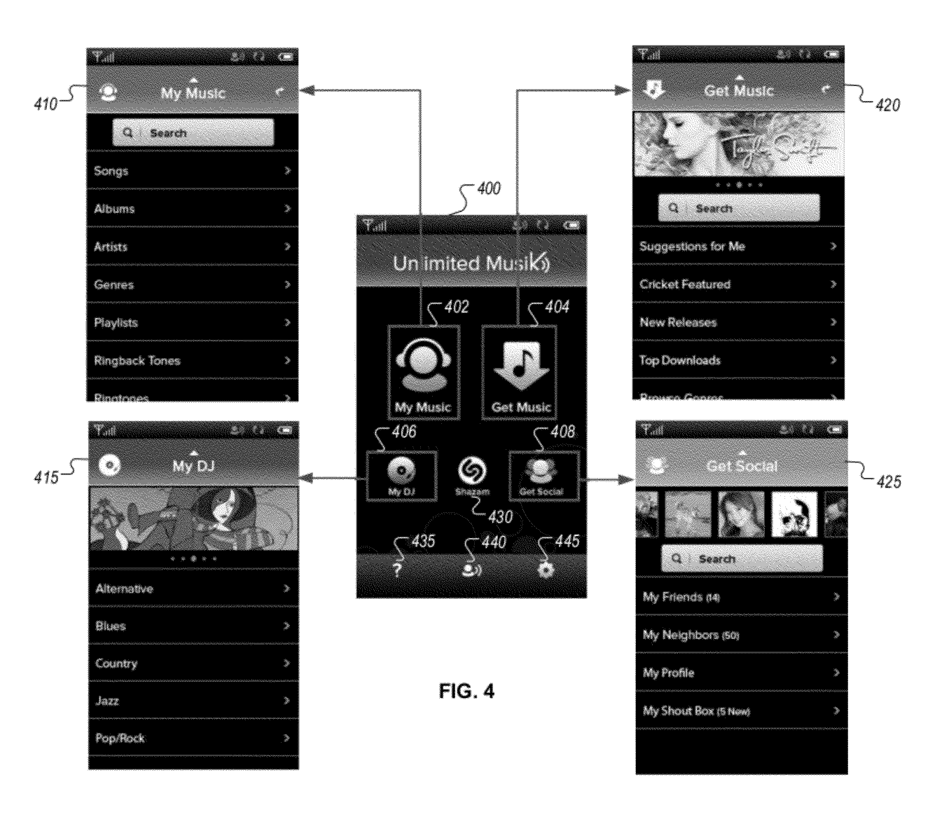

FIG. 4 shows exemplary media interfaces associated with a media application that can be presented by a mobile communications device. A home media interface 400 can be presented, which can provide access to functional areas within the media application as well as access to one or more utilities. The home media interface 400 can be the top-level interface for the media application. Home media interface 400 can include selectable icons corresponding to functional areas, including MyMusic icon 402, GetMusic icon 404, MyDJ icon 406, and GetSocial icon 408. An icon can be selected (or actuated) through any known technique, including through touch and cursor designation. The icons presented are representative and other implementations can include fewer, more, and/or different icons.

MyMusic icon (or button) 402 can be selected to present a local media interface 410, which can provide access to and browsing of the local media archive stored on the mobile communications device. The local media interface 410 can include categories by which the locally stored media can be sorted, including songs, albums, artists, genres, playlists, ringtones, and ringback tones. One or more other categories also can be included, such as music videos, television shows, and movies. Selecting a category from the local media interface 410 can present another interface, hierarchically organized as a sub-interface, that shows media corresponding to that category, allowing a user to traverse the local media archive. The local media interface 410 also can include a search tool, which can be used to search the local media archive, e.g. using keyword searching.

GetMusic icon 404 can be selected to present a remote media interface 420, corresponding to a remote music archive or media store. The remote media interface 420 can provide access to and browsing of the remote media archive and can be configured to include categories by which the media is organized. For instance, the remote media interface 420 can include one or more categories corresponding to the local media interface 410, such as songs, albums, artists, genres, playlists, ringtones, and ringback tones. The remote media interface 420 also can include one or more other categories, including personalized suggestions, featured media, new releases, and top downloads, e.g. for a predetermined period of time, such as a day, week, or month. Selecting a category from the remote media interface 420 can present another interface, hierarchically organized as a sub-interface, that shows media corresponding to the selected category, allowing a using to traverse the remote media archive. The remote media interface 420 also can include a search tool, which can be used to search the remote media archive, e.g. using keyword searching.

MyDJ icon 406 can be selected to present a playlist interface 415, which can provide access to and browsing of the playlists available to the mobile communications device. The playlists can include either or both of local playlists, e.g. generated by the user of the device, and remote playlists that are generated by an external provider, such as another user or the system operator. The playlist interface 415 can include categories by which the playlists can be sorted, such as genre, content, and playlist source. For instance, the playlists can be organized using genres such as alternative, blues, country, jazz, and pop/rock. Selecting a category from the playlist interface 415 can present another interface, hierarchically organized as a sub-interface, that shows playlists corresponding to that category. In some implementations, the playlists shown can include playlists that are presently available, e.g. local playlists and subscribed playlists, and playlists that are not presently available but can be subscribed to. Further, the playlists that are presently available can be visually distinguished from those that are not, such as through highlighting or through the association of a graphical identifier.

GetSocial icon 408 can be selected to present a social interface 425, which can provide access to the subscriber's community. The community can include connected friends who also are subscribers to the media service, identified neighbors, and a Shout box that provides access to messaging within the media application and service. Further, the social interface 425 can provide access to the subscriber's profile, which can be used to describe and publicize subscriber characteristics, including musical preferences and the subscriber's local media archive. The social interface 425 also can include a search tool, which can be used to search the subscriber's social connections, e.g. using keyword searching.

Additionally, home media interface 400 can present one or more utility icons, which can be accessed to perform operations corresponding to the media application. For instance, a music recognition icon 430 can be selected to capture audio and submit it to a music recognition service. Also, a help icon 435 can be selected to access help, e.g. instructions or demonstrations, relating to one or more features and functions of the media application. A help interface organized by topics, such as functions, can be presented in response to selection of the help icon 435. In some implementations, a full tutorial for the media application also can be accessed.

A Shout icon 440 can be selected to access a Shout interface presenting the subscriber's Shout message box. The Shout message box can include Shout messages to and between all members of the subscriber's community. Further, the Shout interface can include an option to view only Shouts addressed to the subscriber and/or sent by the subscriber. Additionally, the home media interface 400 can include a settings icon 445, which can be selected to view and alter one or more media application settings, including synchronization status settings, social settings, card settings, and parental controls.

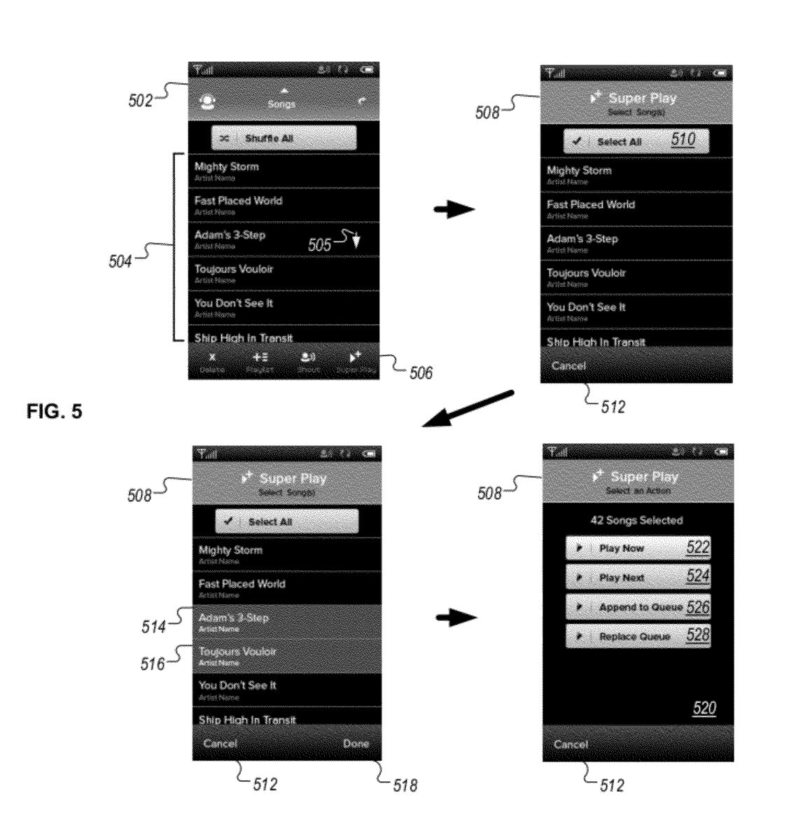

FIG. 5 shows exemplary interfaces associated with play queue management that can be presented by a mobile communications device. The media application can maintain a play queue for media playback by the mobile communications device. At any time, the play queue can include zero or more items of media, e.g. songs. Further, the media application's play queue can be managed from one or more of the functional areas of the media application, such as the MyMusic, GetMusic, MyDJ, and GetSocial functional areas. Play queue management can be accessed at any time by selecting a play queue (or “SuperPlay”) icon or command button presented in an interface.

For instance, a songs interface 502 corresponding to an album for which one or more tracks are stored in the local media archive can be presented. The songs interface 502 can identify the name of the album, e.g. Fast Paced World, and can include a track listing 504 identifying all of the tracks included on that album or only the tracks included in the local media archive. The track listing 504 can be scrollable and/or resizable if the number of tracks exceeds the amount of available display space in the interface. If the names of all tracks are displayed, the names of tracks that are stored in the local music archive, e.g. in MyMusic, can be visually distinguished from the names of the remaining tracks, such as through highlighting, text color, shading, or the presentation of a graphical device. Further, a download indicator 505 can be presented in association with a track in the track listing 504 that is in the process of being downloaded. Additionally, the songs interface 502 can feature one or more user selectable command buttons, e.g. at the bottom of the interface, including a SuperPlay button 506.

The SuperPlay button 506 can be selected to manage the playback queue of the media application. If no songs are playing and no songs have been selected for playback, the playback queue is empty. Otherwise, at least one song is included in the playback queue. Selecting the SuperPlay button 506 can cause a SuperPlay interface 508 (or playback queue management interface) to be displayed. The SuperPlay interface 508 can show the same items of media content as the interface from which the SuperPlay button 506 was selected, e.g. the songs interface 502 corresponding to an album, e.g. Fast Paced World. The SuperPlay interface 508 can be configured to permit one or more tracks from the track listing 504 to be selected. For instance, a select all button 510 can be actuated to select all of the tracks. Also, one or more tracks can be selected or deselected individually, by actuating the corresponding entry in the track listing 504. If a track has not been selected, actuating the corresponding track listing, e.g. in a touch-interface, causes the track to be selected. Conversely, if a track has been selected, actuating the corresponding track listing causes the track to be deselected. A cancel button 512 also can be presented in the SuperPlay interface 508. Selecting the cancel button 512 can cause the media application to exit the SuperPlay function without amending the playback queue, and any selections that had been made can be discarded.

A track that has been selected can be visually identified in the track listing 504, e.g. by highlighting the track entry or by altering either or both of the text color and the background color. For instance, the selected tracks Adam's 3-Step 514 and Toujours Vouloir 516 can be presented using a different background color to distinguish them from the remaining tracks that have not been selected. Additionally, a done button 518 can be presented in the SuperPlay interface 508, e.g. upon selection of the first track, to indicate that track selection is complete.

In response to selection of the done button 518, a SuperPlay summary 520 can be presented in the SuperPlay interface 508 to indicate the state of the playback queue and to provide for playback queue management. For instance, the SuperPlay summary 520 can indicate how many selected tracks are presently included in the playback queue. Further, the SuperPlay summary 520 can include one or more command buttons, such as the PlayNow button 522, PlayNext button 524, AppendtoQueue button 526, and ReplaceQueue button 528. Selecting the PlayNow button 522 causes playback of the first of the newly selected tracks to begin immediately. Selecting the PlayNext button 524 causes playback of the first of the newly selected tracks to begin after the presently playing song ends. Selecting the AppendtoQueue button 526 causes the one or more selected tracks to be added to the end of the existing playback queue. Also, selecting the ReplaceQueue button 528 causes the tracks previously in the playback queue to be discarded and the playback queue to be populated only with the newly selected tracks.

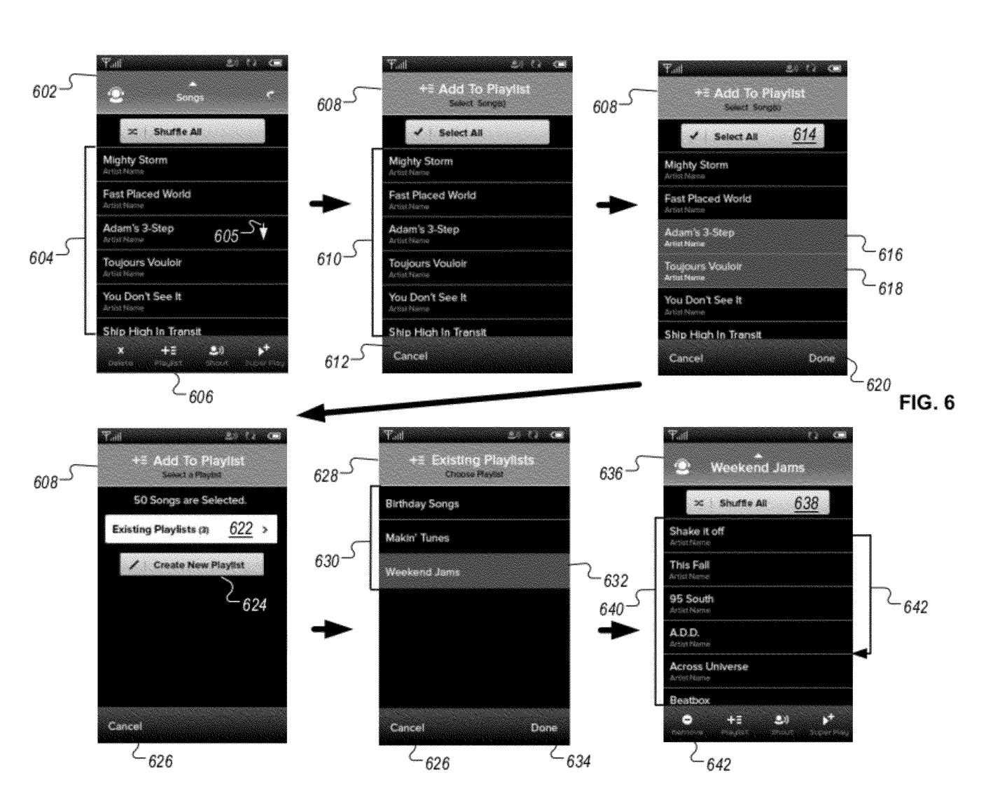

FIG. 6 shows exemplary media application interfaces associated with playlist management that can be presented by a mobile communications device. The media application can be configured to generate, maintain, and/or access playlists, each of which can reference one or more items of media. A local playlist can be generated by a subscriber based on items of media content stored in the local media archive. The subscriber also is free to modify or delete the local playlist at any time. Further, one or more remote playlists, which are created and maintained by an entity other than the subscriber, also can be subscribed to. Once a subscription to a remote playlist has been established, the media content corresponding to that playlist can be downloaded to the local media archive. In some implementations, the remote playlist can be compared with the local media archive and only media content that is not already stored in the local media archive is identified for downloading. As long as the subscription to the remote playlist is active, the local media archive can be automatically updated to reflect changes to the remote playlist, e.g. an item of media content can be automatically added to the local media archive in response to the addition of that item of media content to the remote playlist. Additionally, a subscriber can save a copy of the remote playlist as a local playlist, which can then be modified in accordance with the subscriber's preferences.

The media application can be configured to permit creating a local playlist from one or more of the functional areas, such as the MyMusic, GetMusic, MyDJ, and GetSocial functional areas. Playlist generation can be initiated by selecting a playlist icon or command button presented in an interface. The interface can correspond to local content, i.e., one or more songs already stored in the local media archive, or remote content, such as a listing of one or more songs associated with the media store or the local media archive of another subscriber. For instance, a songs interface 602 corresponding to an album for which one or more tracks are stored in the local media archive can be presented. The songs interface 602 can include a track listing 604 identifying all of the tracks included on that album or all of the tracks stored in the local media archive. The track listing 604 can be scrollable and/or resizable if the number of tracks exceeds the amount of available display space in the interface. If all names are included, the names of tracks that are stored in the local media archive, e.g. in MyMusic, can be visually distinguished from the names of the remaining tracks, such as through highlighting, text color, shading, or the presentation of a graphical device. Further, a download indicator 605 can be presented in association with a track in the track listing 604 that is in the process of being downloaded. Additionally, the songs interface 602 can feature one or more user selectable command buttons, e.g. at the bottom of the interface, including a playlist button 606.

A playlist interface 608 can be presented in response to selection of the playlist button 606. The playlist interface 608 can include a track listing 610, which corresponds to the track listing 604 of the songs interface 602 from which the playlist button 606 was selected. Further, the playlist interface 608 can include a cancel button 612, which can be selected to exit the playlist function without making any changes.

One or more tracks can be selected from the track listing 610. For instance, a select all button 614 can be included to select each of the tracks in the track listing. Also, one or more tracks can be selected or deselected individually, e.g. by touching the track name in the track listing 610. For instance, the tracks Adam's 3-Step 616 and Toujours Vouloir 618 can be individually selected from the track listing 610. If a track has not been selected, actuating the corresponding track listing, e.g. in a touch-interface, causes the track to be selected. Conversely, if a track has been selected, actuating the corresponding track listing causes the track to be deselected. The select all button 614 and individual selection/deselection also can be used in conjunction, e.g. to select all displayed tracks and then to deselect one or more individual tracks.

A track that has been selected can be visually identified in the track listing 610, e.g. by highlighting the track entry or by altering either or both of the text color and the background color. For instance, the selected tracks Adam's 3-Step 616 and Toujours Vouloir 618 can be presented using a different background color to distinguish them from the remaining tracks that have not been selected. Additionally, a done button 620 also can be presented in the playlist interface 608, e.g. upon selection of the first track, to indicate that track selection is complete.

Upon selection of the done button 620, one or more command options can be presented in the playlist interface 608, such as an existing playlist button 622 and a create new playlist button 624. The existing playlist button 622 also can indicate the number of existing playlists. Selecting the create new playlist button 624 can cause a new playlist to be generated, which includes each of the presently selected tracks. Also, a user interface or command tool can be presented to permit the subscriber to name the newly created playlist. Alternatively, selecting the existing playlist button 622 can cause an existing playlist interface 628 to be presented. The existing playlist interface 628 can include a playlist listing 630 that identifies each of the local playlists available to the mobile communications device. A local playlist can be selected from the playlist listing 630, such as by touching the local playlist name or by designating it with a cursor. In some implementations, selecting a local playlist name, e.g. Weekend Jams 632, can cause a corresponding local playlist interface to be presented. In some other implementations, a done button 634 can be selected to finalize the selection.

The tracks selected through the playlist interface 608 can be added to the local playlist selected from the playlist listing 630, e.g. Weekend Jams 632. Further, a corresponding local playlist interface 636 can be presented for the selected playlist, e.g. Weekend Jams 632, to show the associated track listing 640. Additionally, the sequence of the associated tracks can be edited in the local playlist interface 636. For instance, a shuffle all button 638 can be selected to reorder all of the associated tracks, e.g. randomly. An individual track also can be repositioned within the track listing 640, such as by a drag-and-drop operation 642. Also, a remove button 644 included in the local playlist interface 636 can be selected to remove one or more selected tracks. In some implementations, the subscriber can be prompted to save the edited playlist after one or more tracks have been removed or the playlist has been reordered.

Also, a download operation can be initiated for each media item, e.g. track, added to a playlist of which a copy is not stored in the local media archive. The download operation can be immediate, such that transfer of the media item to the local archive begins when the operation is received. Alternatively, the download operation can be delayed, such as until the media item is needed for playback or until the next synchronization operation is performed.

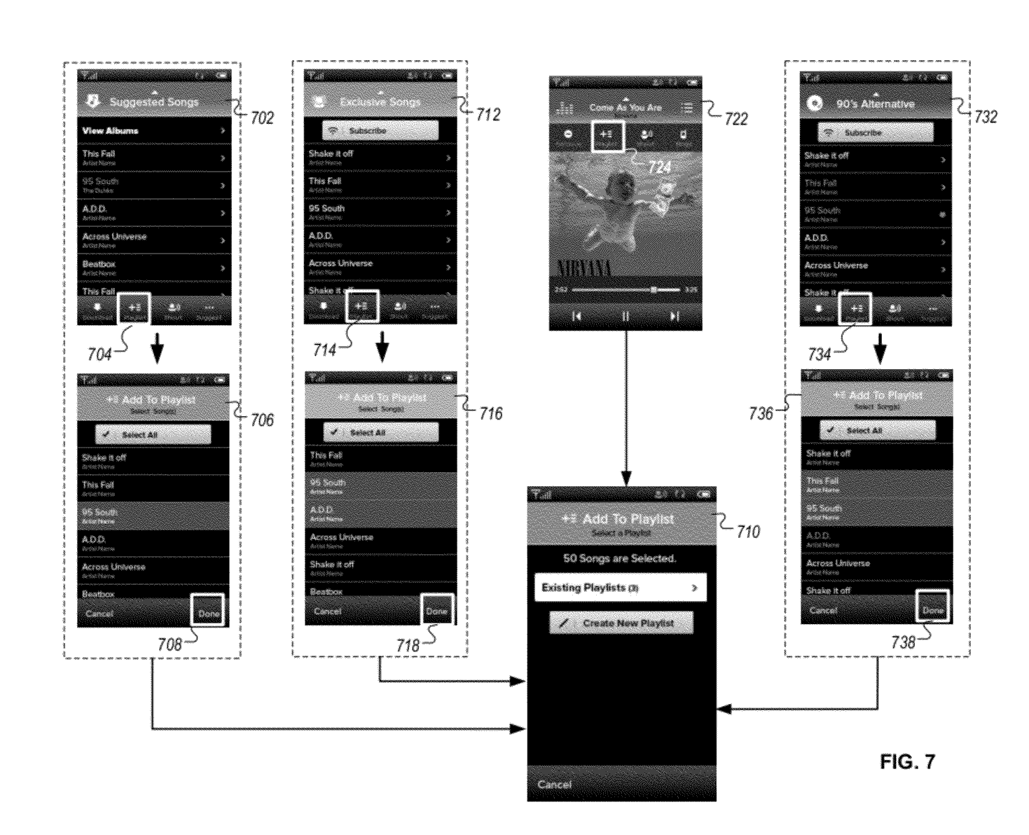

FIG. 7 shows exemplary playlist management interfaces corresponding to a variety of functional areas. Playlist management can be performed from one or more functional areas of the media application, by selecting a playlist icon or playlist command button presented in an interface. For instance, an interface displaying one or more items of media content, either local or remote, also can include a playlist command button, which can be actuated to add any selected item or items of media content to a playlist.

For instance, a playback interface 722 can be presented during playback of an item of media content, e.g. a song. The playback interface 722 can include one or more user interface commands, controls, and widgets, e.g. implemented using buttons and sliders, that can be used to control playback. The playback interface 722 also can include a playlist button 724, which can be selected to add the item of media content being played back to a playlist. Upon selection of playlist button 724, a playlist management interface 710 can be presented. The playlist management interface 710 can function as described with respect to FIG. 6. For instance, the playlist management interface 710 can include an option to view the existing playlists to which the selected media content can be added. The option also can indicate how many existing playlists can be modified to include the selected media content. Selecting the option can cause the editable, local playlists to be presented. Also, the playlist management interface 710 can include an option to create a new playlist based on the selected media content. Selecting the option to create a new playlist can cause an input interface to be presented, such that a user can assign a name or other identifier to the newly created playlist.

Other interfaces of the media application also can include a playlist command button. For instance, a GetMusic interface 702 showing a list of suggested songs (or tracks) can include a playlist command button 704. Also, a GetSocial interface 712 showing a list of songs that are exclusive to the user or another subscriber, e.g. a friend or neighbor, can include a playlist command button 714. Further, a MyDJ interface 732 showing a list of songs associated with a playlist also can include a playlist command button 734. Selecting the playlist command button 704, 714, or 734 can cause a corresponding playlist selection interface 706, 716, or 736 to be presented. The playlist selection interface can include a listing of the same media content items presented in the preceding interface and can be configured to permit any or all of those media content items to be selected. After one or more of the media content items have been selected, a done button 708, 718, or 738 included in the playlist selection interface can be actuated to advance to the playlist management interface 710, through which the selected items of media content can be added to an existing playlist or a new playlist can be created based on the selected items of media content.

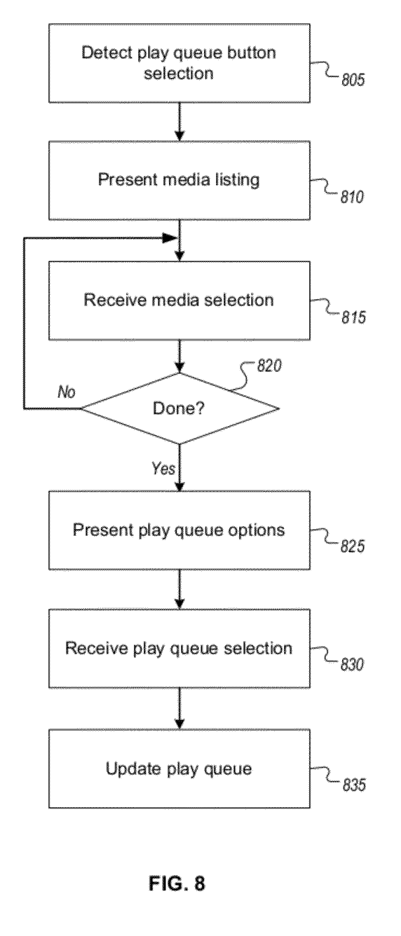

FIG. 8 shows an exemplary process flow for play queue management. The media application can maintain a play queue that includes zero or more songs that are ordered for playback. Further, the play queue can be updated (or modified) at any time, including during playback of an item of media content. Updating of the play queue can be initiated in response to detecting the selection of a play queue (or SuperPlay) button (805). A play queue button can be included in various interfaces of the media application, such as interfaces that identify one or more items of media content.

A media listing can be generated and presented in response to the selection of the play queue button (810). The media listing can include one or more items of media content shown in the interface from which the play queue button was selected. Further, the media listing can include zero, one, or more additional items of media content. The selection of an item of media content from the media listing can be received (815) and it can be determined whether any more selections are to be made (820). For instance, it can be determined whether input indicating an end of the media selection, e.g. a done command, has been received. If media selection is on-going, an additional media selection can be received (815).

Otherwise, one or more play queue options can be presented (825). For instance, the play queue options can include an option to begin playback of the one or more selected items of media content immediately. Beginning playback of the one or more selected items can cause playback of one or more presently playing media items to be canceled or suspended. The play queue options also can include an option to play the one or more selected items of media content after playback of the presently playing song has completed. Further, the play queue options can include an option to append the one or more selected items of media content to the existing play queue and an option to discard the existing play queue and generate a new play queue based on the selected items of media content. The selection of one of the presented play queue options can be received (830) and the play queue can be updated accordingly (835).

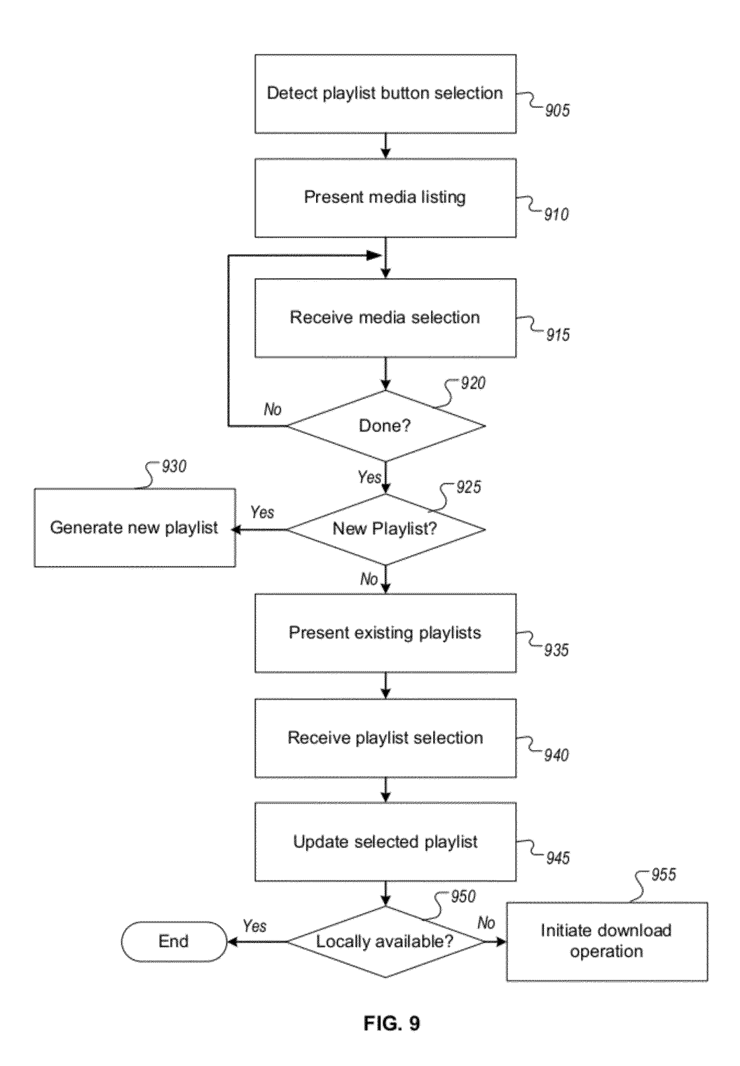

FIG. 9 shows an exemplary process flow for playlist management. A playlist button can be included in various interfaces of the media application, such as interfaces that identify one or more items of media content, including local interfaces and remote interfaces, e.g. one or more GetMusik and GetSocial interfaces. The selection of the playlist button can be detected (905) in an interface and a playlist management process can be initiated. A media listing can be generated and presented in response to the selection of the playlist button (910). The media listing can include one or more items of media content shown in the interface from which the playlist button was selected. Further, the media listing can include zero, one, or more additional items of media content. The selection of an item of media content from the media listing can be received (915) and it can be determined whether any more selections are to be made (920). For instance, it can be determined whether input indicating an end of the media selection, e.g. a done command, has been received. If media selection is on-going, an additional media selection can be received (915). Otherwise, it can be determined whether a new playlist is to be created (925). For instance, a playlist interface can be presented, prompting the subscriber to select an option to create a new playlist or to modify an existing playlist.

If a new playlist is to be created, an interface can be provided to permit assigning an identifier to the new playlist and the new playlist can be generated (930). Alternatively, a playlist identifier can be automatically generated. Otherwise, a listing of one or more existing playlists can be presented (935) and one of the existing playlists can be selected (940). The selected playlist can then be updated to include the one or more selected items of media content (945). Additionally, it can be determined whether any item of selected media content is not presently stored in the local media archive (950). If an item of selected media content is not stored in the local media archive, a download operation can be initiated to transfer the item of media content (955).

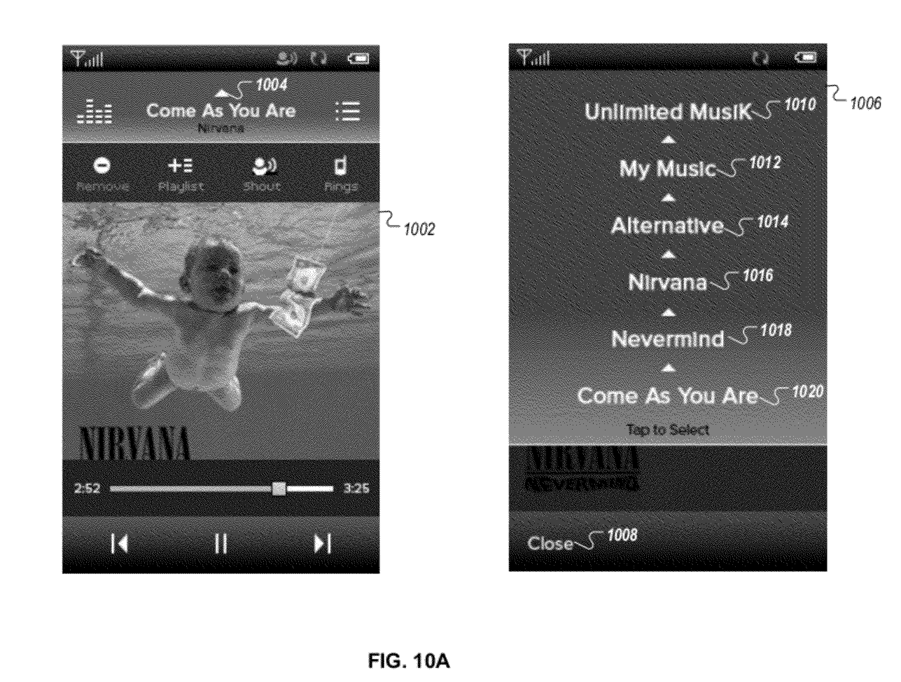

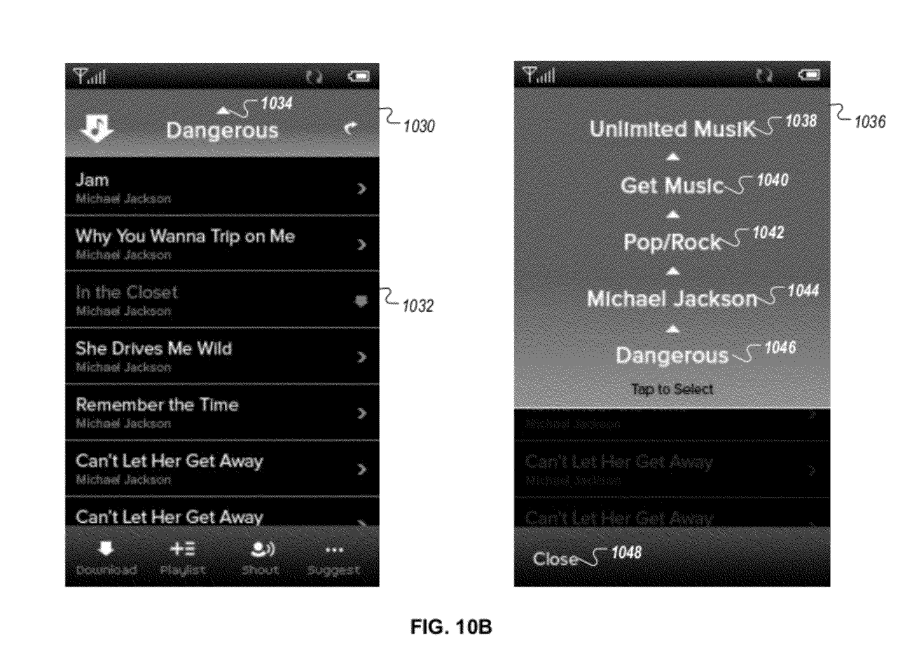

FIGS. 10A and B show exemplary navigation interfaces associated with the media application. The media application can be configured to permit a user to determine, from any or all interfaces, their present level within the navigation hierarchy and to transition to a new level in the hierarchy without traversing each intervening level. In FIG. 10A, playback interface 1002 can be presented during playback of an item of media content, e.g. a song such as Come As You Are by Nirvana. Playback interface 1002 can include one or more playback controls, e.g. seek and pause, and a media timeline to indicate how much of the item has been played and how much remains. Playback interface 1002 also can include a title bar, e.g. presenting artist and title information, that has one or more associated controls, including a navigation prompt 1004. Selecting the navigation prompt 1004, e.g. using touch or a cursor, can cause a navigation interface 1006 to be presented.

Navigation interface 1006 can present a representation of the hierarchical navigation tree within the media application, including the present location (or node) within the navigation tree. In one example, the hierarchical navigation tree can be presented as a list of each application level from the media application's top level (or home) interface, e.g. Unlimited Musik 1010, to the present hierarchical level, e.g. the media playback level 1020 for the song Come As You Are. The list also can include each intervening level in the hierarchical tree. For instance, the second entry in the list can indicate the functional area to which the subscriber has navigated, e.g. MyMusic 1012, which is the functional area corresponding to the local media archive. The third entry in the list can indicate a genre selection within the MyMusic functional area, e.g. Alternative 1014. The next entry in the list can identify the artist that has been selected within the genre category, e.g. Nirvana 1016. Further, the next entry in the list can identify the album associated with the selected artist, Nirvana, within which the present media item has been organized, e.g. the album Nevermind 1018. Each of the entries 1010-1020 in the list thus represents a level within the media application interface hierarchy and shows the navigation path between the application home screen and the present interface.

Further, navigation interface 1006 can be adapted to permit navigation to any other level in the hierarchy. For instance, each of the entries 1010-1020 in the list can be selectable. In response to selection of one of the entries 1010-1020, the application can cause the corresponding interface to be displayed. For instance, if the entry Nirvana 1016 is selected, and interface corresponding to that artist's content in the MyMusic functional area can be presented, e.g. listing each album for which one or more songs is stored in the local media archive. Additionally, the navigation interface 1006 can include a close button 1008, which can be selected to close the navigation interface and to return to the previous interface.

FIG. 10B shows a get album interface 1030 within the GetMusic functional area of the media application. Get album interface 1030 can include a list of tracks associated with the album, one or more of which can be selected for downloading. For instance, track 1032 can be visually distinguished, e.g. by color and a graphical indicator, to show that it is presently being downloaded to the subscriber's local media archive. Further, tracks that already are stored in the subscriber's local media archive can be visibly distinguished from the remaining tracks to indicate that they do not need to be downloaded.

Get album interface 1030 also can include a title bar, e.g. presenting title information corresponding to the album for which tracks are being displayed. The title bar can include a navigation prompt 1034, which can be selected to cause a navigation interface 1036 to be presented. The navigation interface 1036 can present a representation of the hierarchical navigation tree within the media application, e.g. between the top level of the application and the present level (or node). For instance, the navigation interface 1036 can indicate that beneath the top level of the application, e.g. Unlimited Musik 1038, the GetMusic 1040 functional area of the application has been accessed. Further, the navigation interface 1036 can indicate that the Pop/Rock 1042 genre of the GetMusic 1040 functional area has been accessed. Additionally, the navigation interface 1036 can indicate that the artist level of the Pop/Rock 1042 genre corresponds to Michael Jackson 1044 and the album level beneath Michael Jackson 1044 corresponds to the album Dangerous 1046.

Navigation interface 1036 also can be adapted to permit navigation to any other level in the hierarchy. For instance, the top level interface of the media application can be accessed by selecting the entry Unlimited Musik 1038. Similarly, the Pop/Rock 1042 genre level can be accessed by selecting that entry and an interface showing all of the artists associated with that genre can be displayed. Accordingly, any number of intervening levels of the navigation hierarchy can be skipped by selecting an entry from the navigation interface 1036. Additionally, the navigation interface 1036 can be closed and the previous interface, e.g. the get album interface 1030, can be displayed in response to selection of the close button 1048.

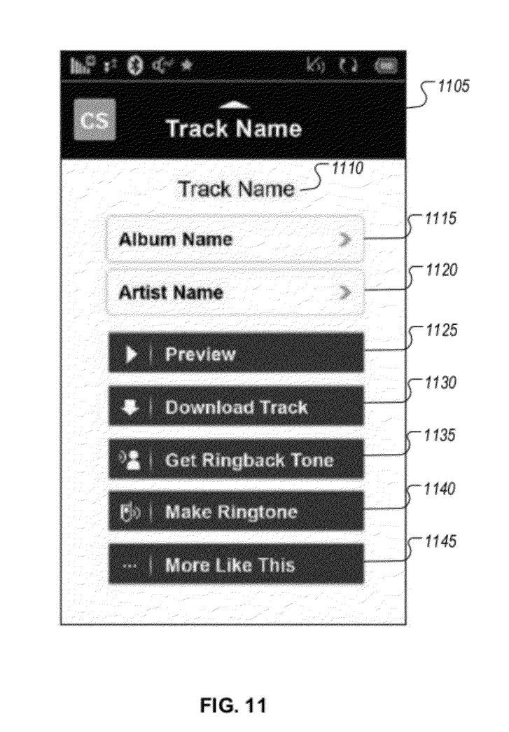

FIG. 11 shows an exemplary interface for performing functions relating to a media item in the unlimited media system. The media item interface 1105 can correspond to a single item of media content, e.g. a music track. A media item identifier 1110 can be presented in the media item interface 1105, which uniquely describes the item. For instance, a track can be identified by its full title, including any or all of artist, album, and performance. Additionally, menu options can be included to permit accessing related media content. For instance, a media collection button 1115, e.g. identified by album name, can be included. The media collection button 1115 can be selected to show other items of media content from the same collection, such as additional tracks on the same album. Also, an artist button 1120 can be included to permit accessing other media content by the same artist. In some implementations, only media content created by that artist can be presented. In some other implementations, media content created by a group that included the identified artist also can be presented.

Further, options for one or more functions associated with the item of media content also can be presented. For instance, a preview button 1125 can be selected to access a preview of the item of media content, such as a 30 second sample of the track. Also, a download button 1130 can be selected to request downloading of the full item of media content to the subscriber's device. A get ringback tone button 1135 can be selected to retrieve a ringback tone that is based on the item of media content. For instance, a ringback tone generated from a portion of a music track can be retrieved. A make ringtone button 1140 also can be selected to permit the subscriber to create a ring tone based on the item of media content. For instance, selecting the make ringtone button 1140 can cause a ring tone creation interface to be presented, in which a subscriber can identify a portion of a music track to use as a ring tone. The subscriber can specify a starting point for the ring tone in the item of media content, e.g., along a media time scale. The subscriber also can define the extent of the ring tone by specifying an ending point or a duration. In some implementations, a default duration can be used if an end point or duration is not specified by the subscriber. Further, the ring tone can be previewed and either accepted or edited further. Additionally, a more like this button 1145 can be included to request the system to identify or recommend similar items of media content.

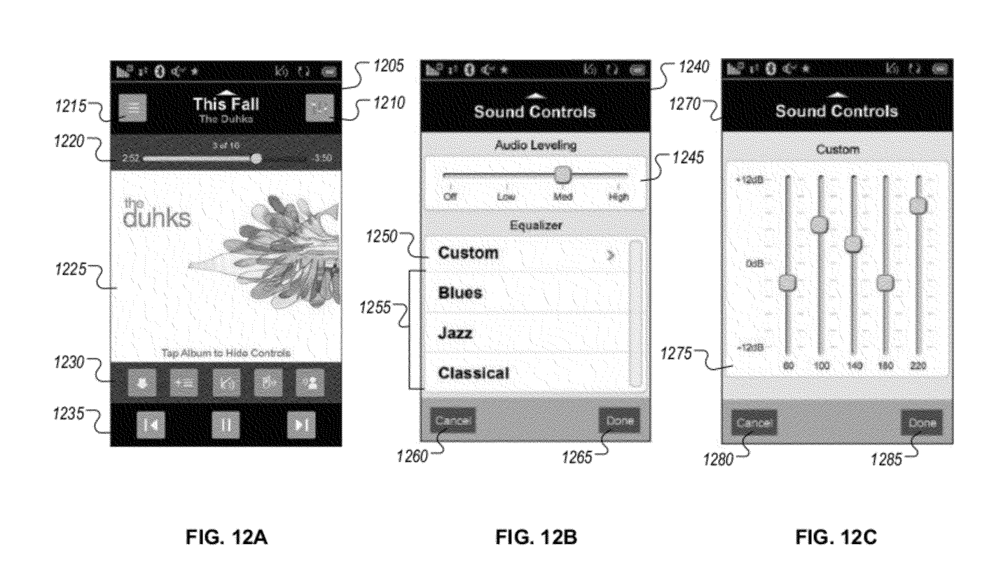

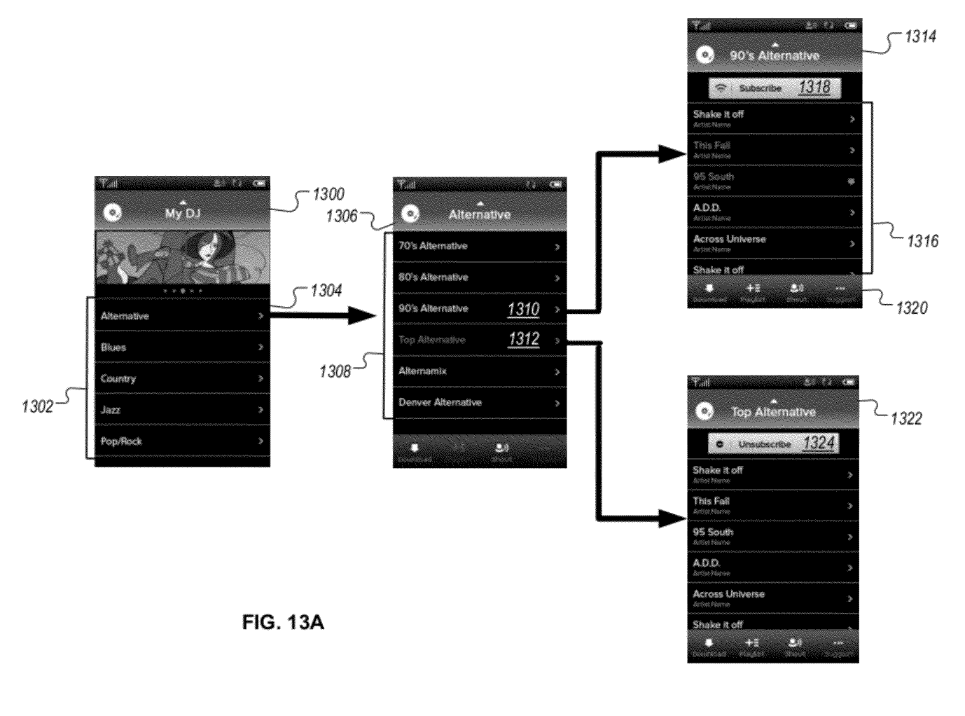

FIGS. 12A-12C show exemplary media application interfaces for controlling the playback of media. FIG. 12A shows playback interface 1205, which can be presented in response to the selection of a media item, e.g. a song. Further, playback interface 1205 also can be presented when a media item is being played back automatically, e.g. during playback of a play list. The playback interface 1205 can include an audio controls button 1210, which can be selected to access audio controls for adjusting one or more playback parameters. A track list icon 1215 also can be presented, which can be selected to return to a track view of the media being accessed, such as a play list or album view.

A playhead indicator 1220 can be presented to indicate the present position of playback within the item of media content. In some implementations, the point of playback can be controlled by moving the playhead with respect to the media timeline. The playhead indicator 1220 also can identify one or more of elapsed playback time, remaining playback time, and total playback duration for the item of media content being played. Further, information indicating the position of the media item in a larger collection, e.g. a play list or album, also can be presented. For instance, if a song being played back is the third track in an album having sixteen total tracks, the text “3 of 16” can be displayed.

A media graphic 1225, such as album art or an image of the artist, also can be presented in the playback interface 1205. In some implementations, one or more control menus can be toggled between displayed and hidden states by selecting the media graphic 1225. For instance, a function control menu 1230 and a playback control menu 1235 can be alternatingly hidden and exposed. The function control menu 1230 can include control elements, e.g. buttons, corresponding to available media service functions. For instance, any or all of a download button, an add to play list button, a shout button, a create ring tone button, and a get ringback tone button can be included in the function control menu 1230. Additionally, the playback control menu 1235 can include one or more playback control elements, e.g. buttons, which can be selected to control playback of the media item. For instance, the playback control menu 1235 can include any or all of a forward seek, reverse seek, and pause/play button.

FIG. 12B shows an exemplary audio controls interface 1240, which can be presented in response to selection of audio controls button 1210. The audio controls interface 1240 can include an audio leveling selector 1245, which can include a range of general audio leveling functions, e.g. from off to high. Further, one or more custom leveling functions also can be provided. For instance, the audio controls interface 1240 can include a custom option 1250, which can be used to specify custom level settings corresponding to one or more channels. One or more genre specific leveling options 1255 also can be provided, e.g. blues, jazz, classical, rock, etc. In some implementations, a genre specific option can be selected first and then customized by selecting custom option 1250. Any changes to the audio leveling can be abandoned by selecting the cancel button 1260 or applied by selecting the done button 1265.

FIG. 12C shows an exemplary custom leveling interface 1270, which can be presented in response to selection of the custom option 1250. Custom leveling interface 1270 can include a control region 1275, in which level controls corresponding to various audio channels can be presented. For instance, sliders corresponding to separate channels can be presented and individually manipulated to specify a custom leveling option. In some implementations, other control mechanisms, e.g. dials, can be used in place of the sliders. Any changes to the audio leveling can be abandoned by selecting the cancel button 1280 or applied by selecting the done button 1285.

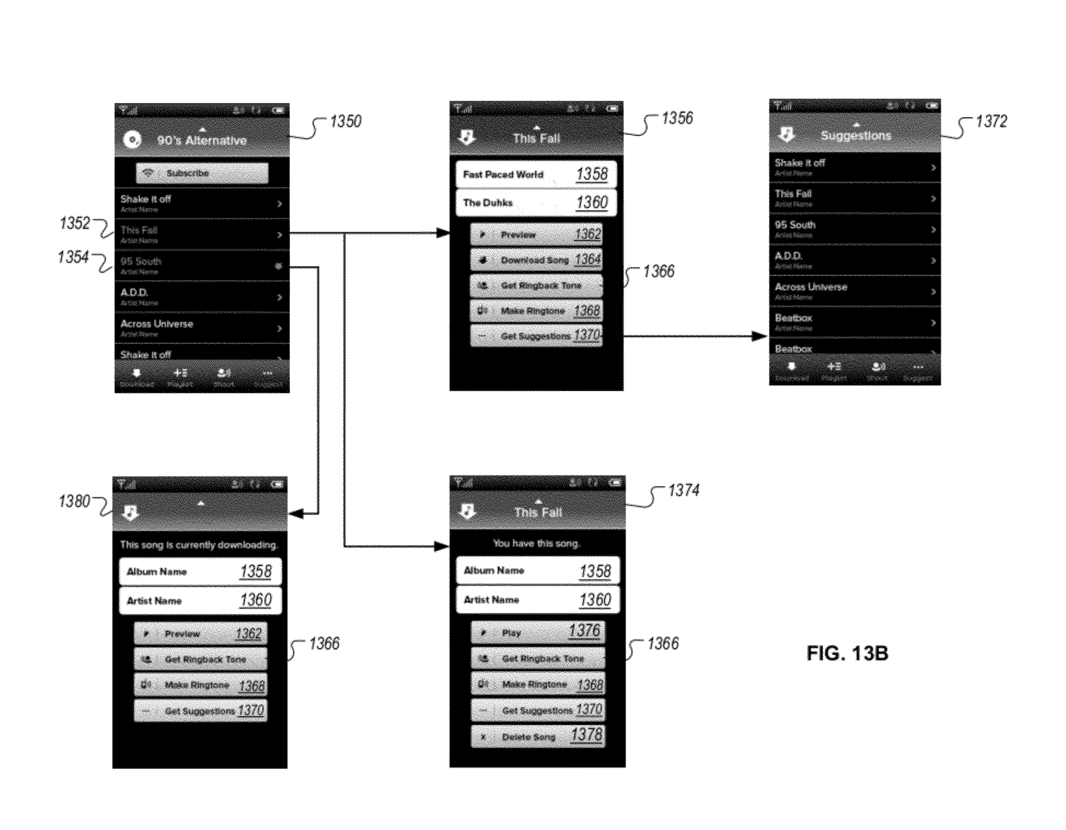

FIGS. 13A and B show exemplary interfaces relating to playlist functionality in the media application. Access to and maintenance of playlists can be performed through the MyDJ functional area of the media application. The playlists can include all playlists accessible to the subscriber, including external playlists created and maintained by third parties, e.g. system administrators and other subscribers, and local playlists created and maintained by the subscriber. The playlists can provide a subscriber with an opportunity to discover media that was previously unknown to them, e.g. by introducing the subscriber to a broad range of music within one or more selected genres. Further, the subscribed playlists can be automatically updated by the party that maintains them. In response to updating, media content added to a subscribed playlist can be automatically downloaded to the local media archive of the subscriber's mobile communications device. In some implementations, media removed from a subscribed playlist also can be removed from the subscriber's local media archive. For instance, a flag, or other such indicator, can be set for an item of media content to indicate that it has been added to the local media archive independent of a subscribed playlist. If the flag is not set for an item of media content removed from a subscribed playlist, the item of media content can be removed from the local media archive when it is removed from the corresponding subscribed playlist. Additionally, the timing of automatic updates for a subscribed playlist can be based on the frequency with which the playlist is accessed. For instance, a frequently accessed playlist can be updated more often than a playlist that is infrequently accessed. Alternatively or additionally, the local media archive can be updated to reflect the current state of a playlist when that playlist is accessed.

FIG. 13A shows a MyDJ interface 1300 corresponding to the home of the MyDJ functional area, which provides access to the available playlists. The view of subscribed, unsubscribed, and local playlists can be organized in any manner within the MyDJ (or playlist) area. In one implementation, the MyDJ interface 1300 can include a list of genres 1302 under which the available playlists can be categorized. For instance, the list of genres 1302 can include an alternative category 1304, which can include one or more sub-categories of alternative music. A genre can be selected from the list of genres 1302 through any input mechanism, including touch or through a cursor.

In response to the selection of a genre, e.g. the alternative category 1304, a genre level interface can be presented, e.g. the alternative interface 1306. The genre level interface can include a list of the available playlists included in that category. For instance, the alternative list 1308 can include entries for each of the available alternative music playlists, such as Alternamix and Denver Alternative. Presently unsubscribed playlists also can be visibly distinguished from subscribed and local playlists, e.g. through text and/or color, or an associated graphical device (e.g. an icon). Thus, a subscriber can visually distinguish existing content that is available for playback from new content that can be explored.

Further, a playlist can be selected from the list of playlists, e.g. alternative list 1308, to view the media associated with that playlist. For instance, the 90's Alternative interface 1314 is presented in response to selection of the entry 90's Alternative 1310 from the alternative list 1308. The 90's Alternative interface 1314 can include a track listing 1316 that identifies the tracks included in the playlist. If a track listing is longer than the available display space, the track listing can be adapted to be scrollable, e.g. through inclusion of a scroll-bar. The track listing 1316 also can be configured such that tracks stored in the local media archive are visibly distinguished from remote tracks, e.g. through text and/or color, or an associated graphical device. Accordingly, the subscriber can determine, in addition to reviewing the track listing, how many tracks in the playlist already are stored locally. Also, the 90's Alternative interface 1314 can include a subscribe button 1318 to facilitate subscription to the playlist through a single-command entry. A suggestion button 1320 also can be included to permit the subscriber to access one or more suggestions for related media content, e.g. playlists, albums, and/or artists.

A playlist that already has been subscribed to also can be selected from the alternative list 1308. For instance, the Top Alternative 1312 playlist can be visibly identified as a subscribed playlist in the list of available playlists. In response to selecting the Top Alternative 1312 entry, the Top Alternative interface 1322 can be displayed. The Top Alternative interface 1322 can include a track listing that identifies each of the tracks presently associated with that playlist. Further, the Top Alternative interface 1322 can include an unsubscribe button 1324 to permit the subscriber to cancel the subscription to that playlist.

FIG. 13B shows selection of a song from a playlist interface. For instance, 90's Alternative interface 1350 can include a track listing showing numerous track names, e.g. This Fall 1352 and 95 South 1354. In response to selecting a track from the track listing, a corresponding track interface can be displayed. The track interface can be differently configured, depending on whether the selected track has been downloaded to the local media archive, is being downloaded to the local media archive, or has not been downloaded to the local media archive.

For instance, if the track This Fall 1352 is selected but has not been downloaded, a remote track 1356 interface can be presented. The remote track 1356 interface can include a number of commands and features, including an album button 1358 that can be selected to view all of the tracks included on the associated album and an artist button 1360 that can be selected to view all of the works, e.g. albums or tracks, by the associated artist. The remote track 1356 interface also can include a preview button 1362 that can be selected to listen to a preview of the track, a download song button 1364 that can be selected to download a copy of the track to the local media archive, a get ringback tone button 1366 that can be selected to download a ringback tone based on the track, a make ringtone button 1368 that can be selected to make a ringtone based on the track, and a get suggestions button 1370 to retrieve one or more suggestions for media content related to the track. For instance, selecting the get suggestions button 1370 can cause a suggestions interface 1372 to be presented that identifies one or more similar tracks that can be downloaded or further accessed.

Alternatively, if the track This Fall 1352 is selected and already has been downloaded, e.g. if a download was requested and has been sufficiently completed, a local track interface 1374 can be presented. The local track interface 1374 can include a number of commands and features associated with the remote track interface 1356, including the album button 1358, artist button 1360, get ringback tone button 1366, make ringtone button 1368, and get suggestions button 1370. Also, the local track interface 1374 can include one or more unique command buttons, such as a play button 1376 to play the track and a delete button 1378 to delete the track from the local media archive.

In response to selection of a track that is still in the process of being downloaded, e.g. 95 South 1354, a download track interface 1380 can be presented. The download track interface 1380 can include a subset of the commands and features associated with the local and remote track interfaces, such as the album button 1358, artist button 1360, preview button 1362, get ringback tone button 1366, make ringtone button 1368, and get suggestions button 1370.

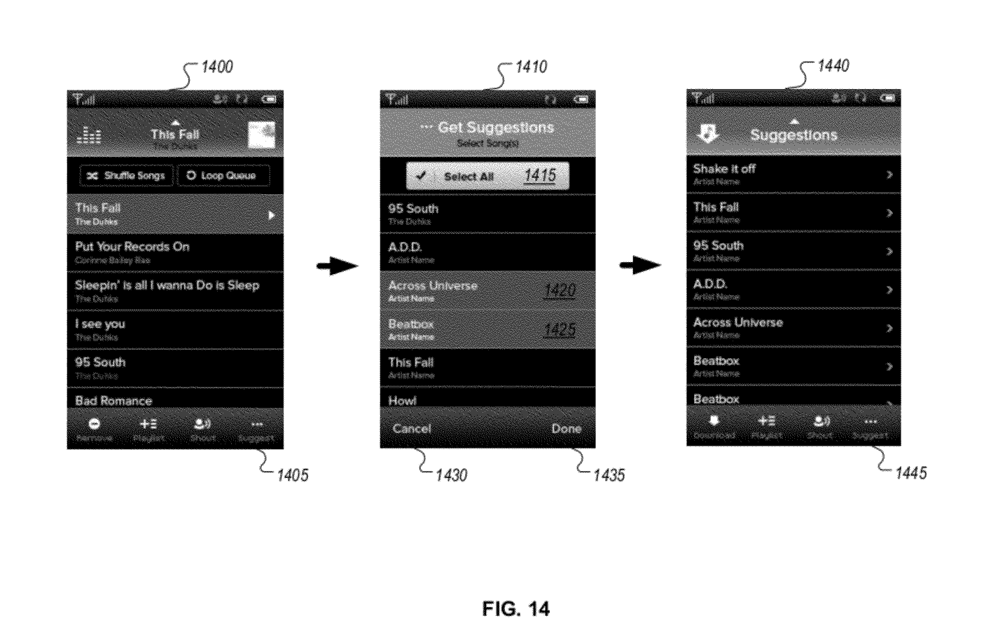

FIG. 14 shows exemplary media application interfaces for receiving suggestions. Suggestions of related media items can be provided in response to the identification of one or more items of media, e.g. songs. The suggestions can be generated based on the similarity between the one or more identified media items and other media items included in an available media archive. In some implementations, subscriber data can be analyzed to determine or refine the degree of relatedness between two items of media content. For instance, if a significant portion of subscribers who have track A in their local media archive also have track B in their local media archive, a measure representing the degree of relatedness between tracks A and B can be increased. The suggestions can be provided by the media service in real-time.

A playlist interface 1400 can be presented, which includes a list of tracks scheduled to be played. The playlist interface 1400 also can include a suggestions button 1405, which can be selected to receive one or more suggested tracks. A suggestion button also can be included in one or more other interfaces, including other MyMusic interfaces and interfaces from the MyDJ, GetMusic, and GetSocial functional areas. In response to selection of the suggestion button 1405, a get suggestions interface 1410 can be presented. The get suggestions interface 1410 can include a listing of tracks, e.g. from the playlist interface 1400. All of the tracks can be selected by actuating the select all button 1415. Alternatively, one or more tracks can be individually selected, such as Across Universe 1420 and Beatbox 1425. The suggestion process can be canceled at any time by actuating the cancel button 1430. Otherwise, the done button 1435 can be actuated once the desired tracks have been selected from the get suggestions interface 1410.

A suggestions interface 1440 can be presented in response to actuation of the done button 1435. The suggestions interface 1440 can include a list of one or more suggested tracks that are related to the one or more tracks selected in the get suggestions interface 1410. Any of the suggested tracks can be downloaded, added to a playlist, or included in a Shout message from the suggestions interface 1440, e.g. by selecting the corresponding command button. Further, one or more of the suggested tracks can be selected and the suggest button 1445 can be actuated to receive further suggestions based on the one or more selected suggested tracks.

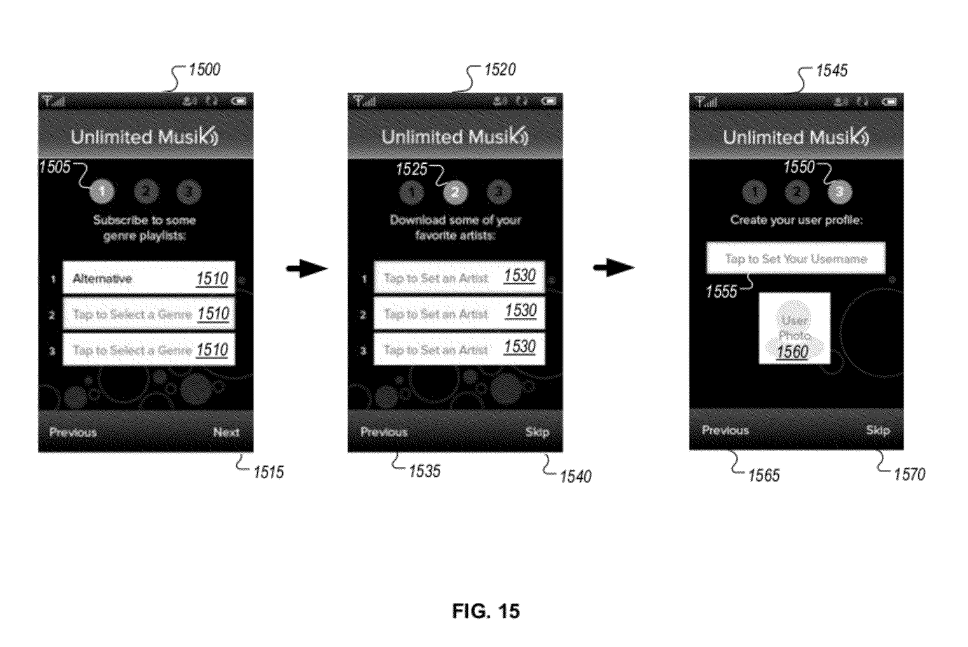

FIG. 15 shows exemplary interfaces associated with a setup wizard of the media application. The setup wizard can be executed at any time, e.g. when a subscriber first initiates service or when the subscriber desires to reconfigure their account. A wizard genre interface 1500 can be presented to receive the specification of one or more genres from the subscriber. The wizard genre interface 1500 can include a step indicator 1505 to indicate which step of the setup process is being performed and also can include one or more instructions, such as “Subscribe to some genre playlists:”. Further, the wizard genre interface 1500 can include one or more genre text boxes 1510 to receive an identification of a genre. A genre text box 1510 can be implemented as a form entry box into which text can be entered, a drop down menu box pre-populated with one or more selectable items, or any other interface element. Alternatively, selecting a genre text box 1510 can cause a genre selection interface to be presented, which can include any combination of interface elements, including any or all of a search box, a text entry box, and a list of selectable genres. A next button 1515 can be provided to permit a subscriber to move to the next step. In some implementations, a skip button can be provided in addition to or in place of the next button 1515, to permit a subscriber to skip this step of the wizard process.

Once one or more artists have been specified or the next button 1515 has been actuated, a wizard artist interface 1520 can be presented. The wizard artist interface 1520 can include a step indicator 1525 to indicate which step of the setup process is being performed, e.g. the second step, and also can include one or more instructions, such as “Download some of your favorite artists”. Further, the wizard genre interface 1520 can include one or more artist text boxes 1530 to receive an identification of an artist. An artist text box 1530 can be implemented as a form entry box into which text can be entered, a drop down menu box pre-populated with one or more selectable items, or any other interface element. Alternatively, selecting an artist text box 1530 can cause an artist selection interface to be presented, which can include any combination of interface elements, including any or all of a search box, a text entry box, and a list of selectable artists. In some implementations, one or more artists can be presented in response to one or more genre selections received through the wizard genre interface 1500. Additionally, a previous button 1535 can be provided to permit a subscriber to return to the previous step and a skip button 1540 can be included to permit a subscriber to skip this step.

Once one or more artists have been specified or the skip button 1540 has been actuated, a wizard profile interface 1545 can be presented. The wizard profile interface 1545 can include a step indicator 1550 to indicate which step of the setup process is being performed and also can include one or more instructions, such as “Create your user profile”. Further, the wizard profile interface 1545 can include a username text box 1555 and a photo box 1560, which can be configured to receive input of username and user photo, respectively. Additionally, a previous button 1565 can be provided to permit a subscriber to return to the previous step and a skip button 1570 can be included to permit a subscriber to skip this step of the wizard process. Upon completion of the wizard process, the subscriber's local media archive can be automatically populated with media corresponding to the one or more identified artists and genres, including subscribed playlists corresponding to the one or more identified genres. Further, additional media content that is related to or otherwise reflects any or all of the identified artist and genre selections also can be automatically downloaded to the subscriber's local media archive.

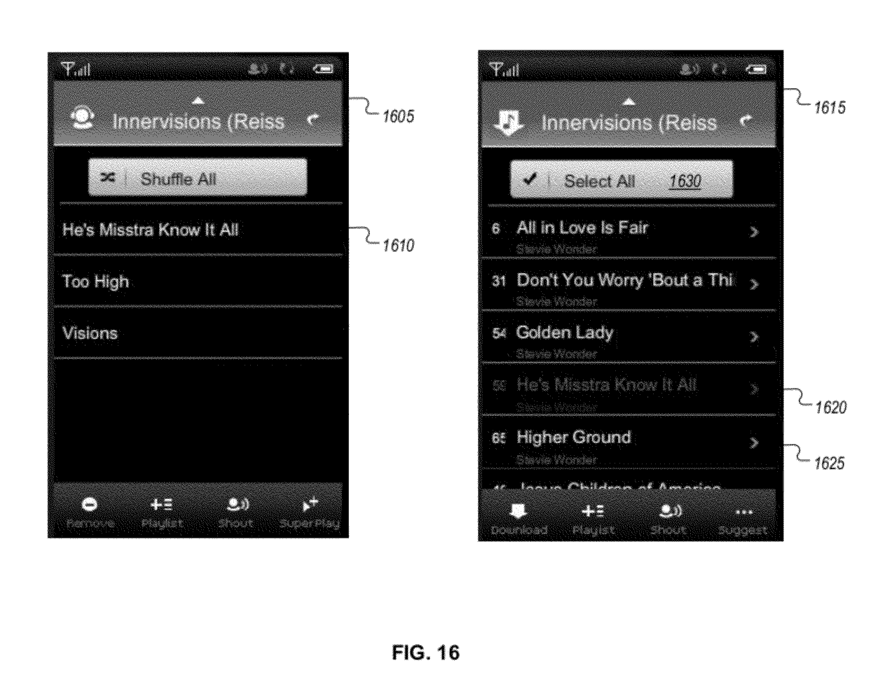

FIG. 16 illustrates an example of accessing related media content corresponding to a remote media archive based on an item of media content stored in a local media archive. A playlist interface 1605, e.g. associated with the album Innervisions, can be presented by a media application at a mobile communications device. The playlist interface 1605 can show all of the locally stored media items associated with a particular category, e.g. an album, artist, playlist, etc. Further, a command can be entered to cause a corresponding view of a remote media archive, e.g. the media or music store, to be displayed. For instance, a button press representing a command to access the media store can be received. In other implementations, any other command can be used to display the corresponding interface, such as input to a touch interface or input to a soft (or virtual) command button or other physical control.

In response to the command, the corresponding interface representing the remote media archive can be presented. The transition from the playback interface 1605 to the view of the remote media archive can be implemented as a direct jump, without requiring the traversal of the application hierarchy. For instance, album interface 1615 representing the album Innervisions in the remote media archive (i.e., the GetMusic functional area) can be presented in response to the command. The album interface 1615 can list each of the tracks included on the album Innervisions that are available for download. Further, the tracks from the album Innervisions that already have been downloaded to the subscriber's local media archive can be visibly distinguished from the tracks that have not been downloaded, e.g. through the use of one or more graphical characteristics. For instance, the track He's Misstra Know It All 1620 can be presented using one font color, e.g. gray, to indicate that it already has been downloaded. The track listing He's Misstra Know It All 1610 appears in the playback interface 1605, indicating that it is local content. Alternatively, the track Higher Ground 1625 can be presented in a different font color, e.g. white, to indicate that it has not been downloaded to the local media archive. Thus, the subscriber can determine visually whether any tracks from the album have not yet been downloaded and can select one or more of those tracks for downloading.

The album interface 1615 also can include a select all button 1630, which can be used to select all of the listed tracks. One or more tracks that already have been downloaded to the local media archive can be individually deselected. Alternatively or additionally, the music service application can determine that one or more of the tracks selected for download already are stored locally at the subscriber's device, e.g. based on the subscriber's instance maintained by the Cloud. As a result, transfer of the selected content that already is locally available can be cancelled and only the selected content that is not locally available can be transferred.

In some implementations, the view of the remote media archive can represent a different hierarchical level, such as artist or genre, or can be a combined view, e.g. listing all tracks associated with the artist that are available for download. A subscriber also can navigate from the album interface 1615 to a different level of the GetMusic hierarchy through any of the available navigation means, including by selecting a node on a displayed hierarchical navigation tree as described in FIGS. 10 A and B. Additionally, another command can be entered to jump directly back to the playback interface 1605 from the album interface 1615.

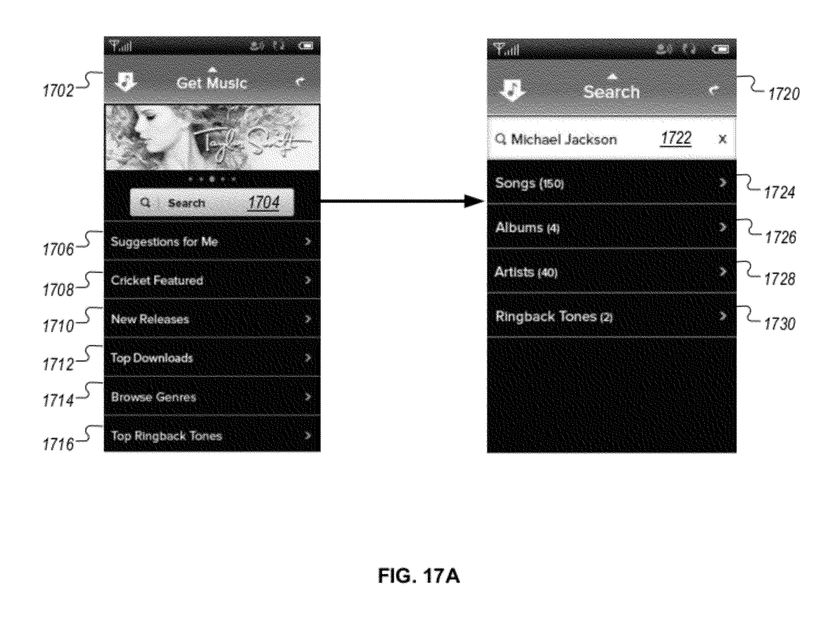

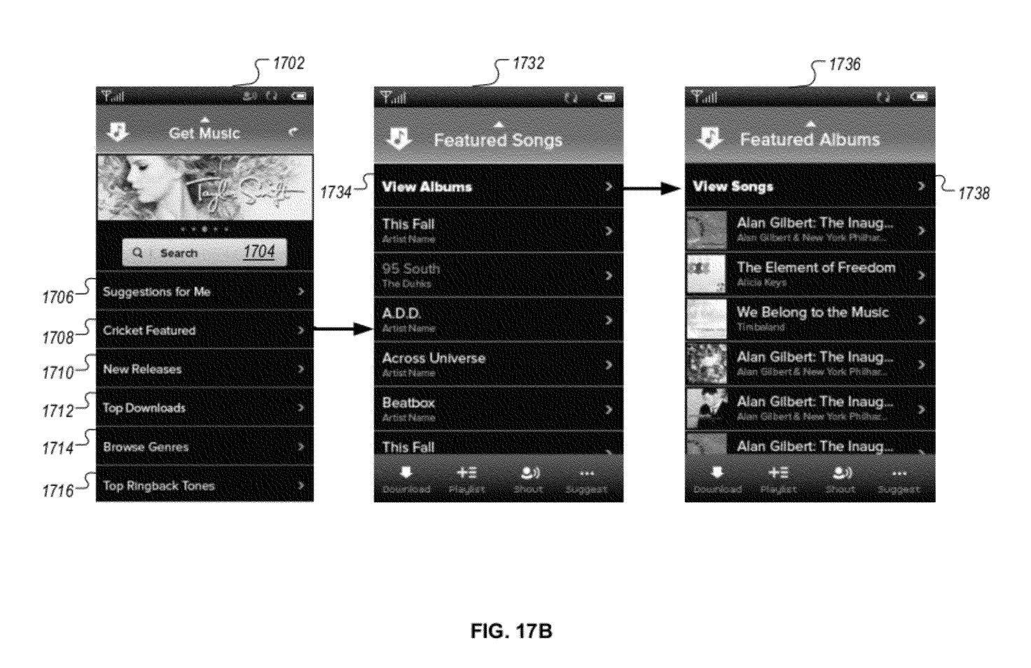

FIGS. 17A and B show exemplary media application interfaces for accessing the remote media archive. As shown in FIG. 17A, the GetMusic interface 1702 can correspond to the top level of the GetMusic functional area, which provides access to the remote media archive. The GetMusic interface 1702 can present one or more options through which media included in the remote media archive can be explored, identified, and downloaded. For instance, the GetMusic interface 1702 can include a search button 1704, which can provide access to a search interface through which searching, e.g. based on artist or title, can be performed. The GetMusic interface 1702 also can include one or more entries through which pre-selected items of media content can be discovered. For instance, a SuggestionsForMe entry 1706 can be selected to view one or more subscriber-specific media recommendations, e.g. based on any or all of the contents of the subscriber's local media archive, the subscribed playlists, and playback history over a period of time. Further, a Featured entry 1708 can be selected to view one or more presently featured media items. The featured media items can be presented for multiple criteria, e.g. album and song, and the views can be toggled as desired. The featured media items for one criteria, e.g. songs, need not correspond to the featured media items for another criteria, e.g. albums.

Also, a new releases entry 1710 can be selected to view one or more media items that were recently released. As with the featured media items, the new releases can be presented for multiple criteria, e.g. album and song, and the views can be toggled. The media items corresponding to one criteria need not correspond to the media items of another criteria. Further, a top downloads entry 1712 can be selected to view the most heavily downloaded media items. The top downloads also can be presented for multiple criteria, e.g. track and album, and the views can be toggled. Additionally, the GetMusic interface 1702 can include a genres entry 1714 that can be organized in accordance with defined genres of media, such as alternative, blues, and classical. Further, a selected genre also can include sub-categories, such as featured media, new releases, and top downloads. Also, the GetMusic interface 1702 can include one or more categories for functional items, such as a get ringback tones entry 1716 or a ringtone entry.

In response to selecting an entry from the GetMusic interface 1702, an interface corresponding to the selected entry can be presented to permit accessing the associated media items. For instance, in response selection of the search button 1704, a search interface 1720 for the remote media archive can be presented. The search interface 1720 can include a search entry field 1722 configured to receive one or more keyword search terms, e.g. relating to an artist or title name. Further, the search interface 1720 can include result categories that can be accessed to view results corresponding to a particular characteristic, e.g. songs 1724, albums 1726, artists 1728, and ringback tones 1730. Also, the number of search results for a particular characteristic also can be presented in the search interface 1720. In any of the media interfaces, one or more of the presented media items can be downloaded to the subscriber's local media archive.

FIG. 17B shows an exemplary featured songs interface 1732, showing featured songs available for download from the remote media archive. In the featured songs interface 1732, the names of featured songs can be presented in a selectable list. In addition to the song title, each entry in the list also can specify one or more other items of information, e.g. artist and/or album title. As previously described, the songs can be listed such that songs that already have been downloaded to the local media archive are visibly distinguished from songs that have not been downloaded.

Further, the featured songs interface 1732 can include a view albums entry 1734, which can be selected to toggle the view. For instance, in response to selection of the view albums entry 1734, a featured albums interface 1736 can be presented. The featured albums interface 1736 can include one or more albums, which can be unrelated to the songs presented in the featured songs interface 1732. Additionally, the featured albums interface 1736 can include a view songs entry 1738, which can be selected to toggle the view to the featured songs interface 1732.

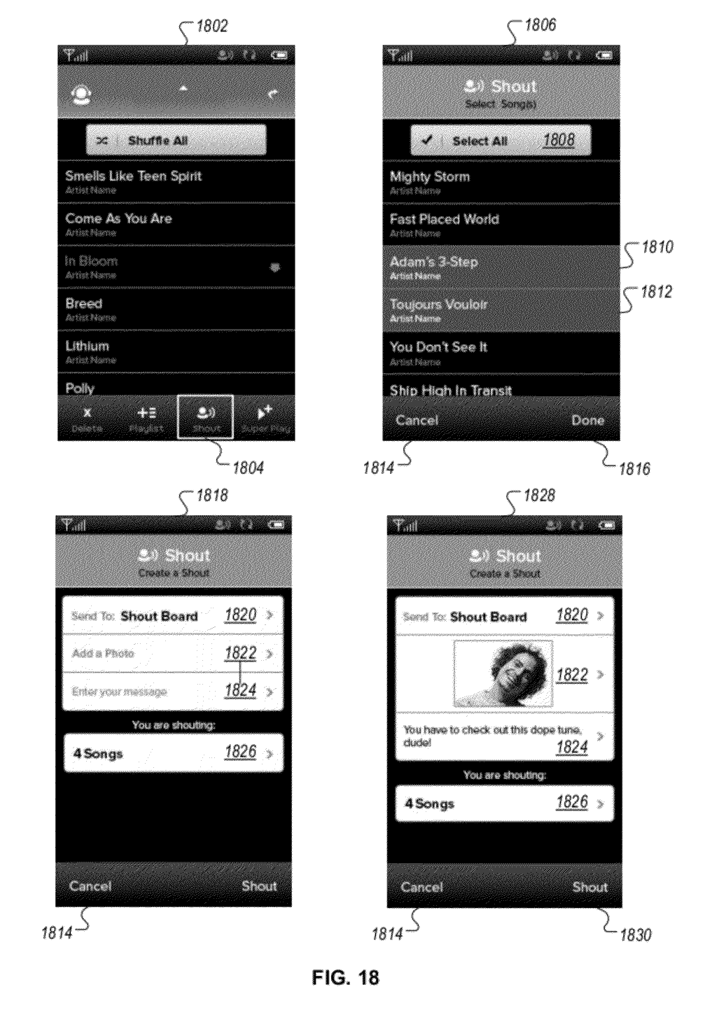

FIG. 18 shows exemplary media application interfaces for generating a message in the media application. A playback interface 1802 can include a shout button 1804, which can be actuated to initiate the generation of a message (or Shout) communicating at least one item of media content. A shout button can be included in any or all of the interfaces included in the functional areas of the media application, such as MyMusic, GetMusic, MyDJ, and GetSocial.

In response to actuation of the shout button 1804, a media selection interface 1806 can be presented. Any type or combination of media can be the subject of a message, including one or more songs, albums, artists, genres, charts, and playlists. The media selection interface 1806 can include the one or more items of media content included in the interface from which the shout button was actuated, e.g. the playback interface 1802. In some implementations, the media selection interface 1806 also can include additional items of media content. For instance, other songs included in an associated album or playlist also can be shown in the media selection interface 1806. Further, one or more of the presented items of media content can be selected. For instance, a select all button 1808 can be actuated to select each of the presented items of media content. Alternatively or additionally, one or more of the presented items of media content can be individually selected or deselected, e.g. through the use of touch or a cursor. Message generation can be terminated at any time by actuating the cancel button 1814, which can return the display to the previous interface. Also, after at least one item of media content has been selected, message generation can be continued by actuating the done button 1816.

A message template 1818 can be presented in response to actuation of the done button 1816. The message template 1818 can include multiple message fields, such as an address field 1820, a photo field 1822, a message field 1824, and a media field 1826. Address field 1820 can be accessed to address the message to one or more recipients, including friends/neighbors from the GetSocial functional area and contacts stored in the mobile communications device. The recipients can be listed individually, as a defined group (or alias), or both. Recipients can be selected from a list included in a recipient interface, such as a list of defined friends or stored contacts. Recipients also can be entered into the address field manually, e.g. using a keypad or voice command. Further, search functionality can be associated with the address field 1820 to permit searching any or all of the media application, the mobile communications device, and one or more networked resources for contact information. A message can be addressed to other subscribers to the media service associated with the media application. Accordingly, those other subscribers can be granted access to the one or more media items associated with the message. In some implementations, the message also can be addressed to non-subscribers, who can receive an identification of the one or more media items, e.g. songs titles, and an identification of the media service through which they can be accessed, e.g. a hyperlink to a service description page or advertisement.

The photo field 1822 can be accessed to associate an image with the message. The image can be selected from one or more previously stored images, including photos, or a new photo can be taken, e.g. with a camera included in the mobile communications device. Once an image has been associated with the message, an option to remove the image also can be presented. Further, the message field 1824 can be accessed to enter text that is to be sent with the message. Accessing the message field 1824 can cause an input interface to be displayed, such as a text box and corresponding keyboard, or a voice input interface. In some implementations, voice data can be associated with the message in place of or in addition to text. The amount of text and/or voice information associated with the message can be limited based on size restrictions.

Additionally, the media field 1826 can indicate information about the one or more media items associated with the message, such as song title or the number of associated media items. The media field 1826 can be accessed to view a list of the media items associated with the message. Further, the list can be used to add one or more media items to the message, delete one or more media items from the message, or both. Message template 1828 shows a completed message, which can be transmitted by actuating the shout button 1830. Recipients who are subscribers to the media service can access a media item associated with the message, e.g. by actuating a corresponding link contained in the message.

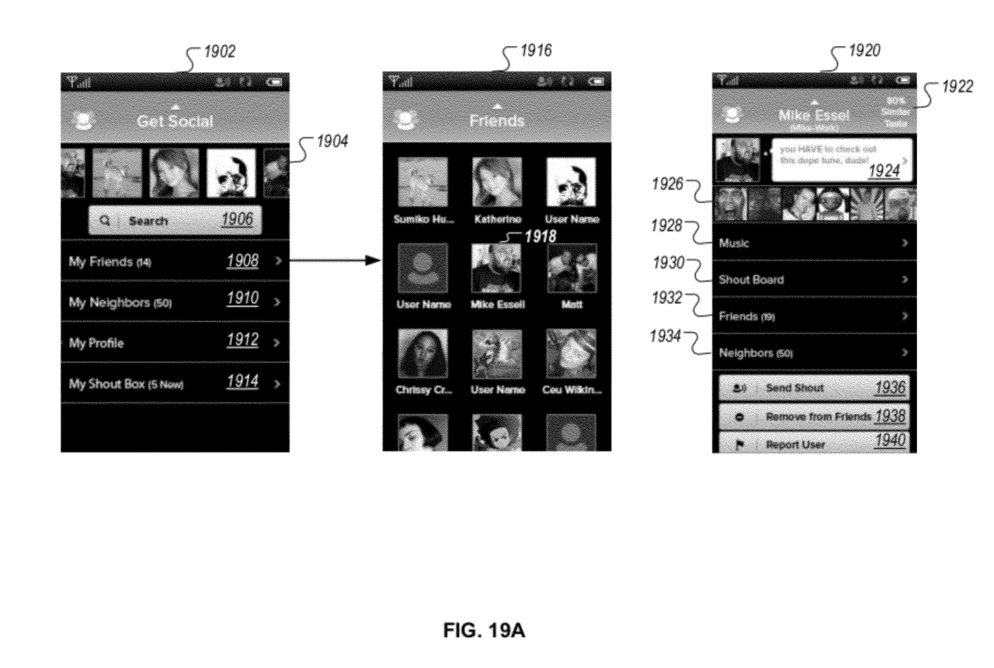

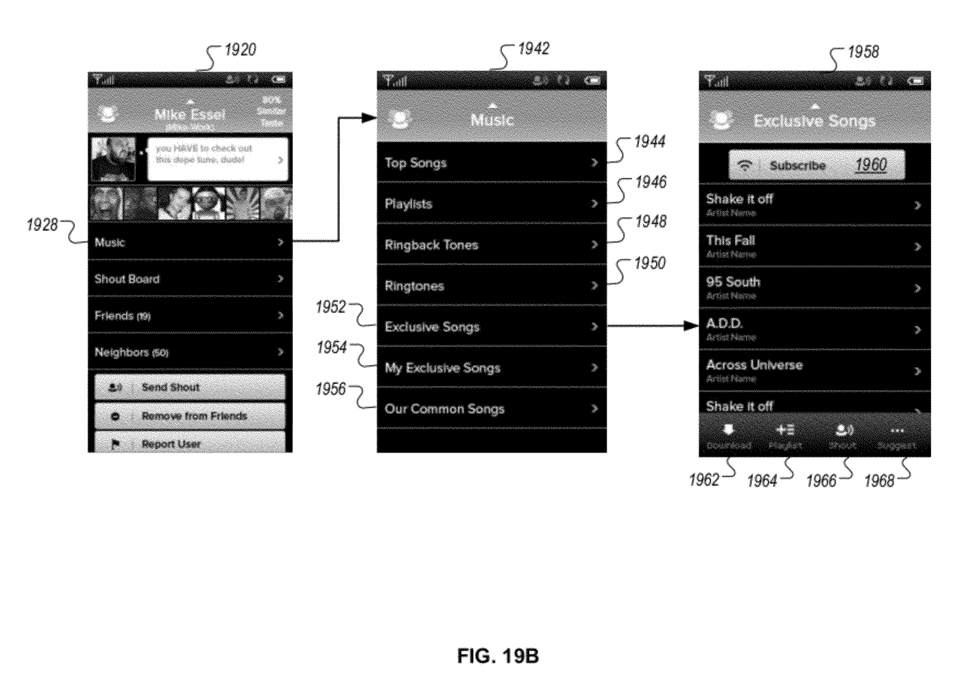

FIGS. 19A and B show exemplary media application interfaces for social interaction in the media application. Social interaction in the media application can be organized through the GetSocial functional area, although aspects of social interaction also can be implemented in one or more other functional areas. A GetSocial interface 1902 can be presented as the top level interface for social functionality. The GetSocial interface 1902 can include features and commands relating to interactions with other subscribers, including subscribers expressly designated as friends and subscribers designated by the media service as neighbors. For instance, the media service can designate one or more other subscribers as neighbors based on one or more factors, such as one or more of geographical proximity, common friends, and media preferences. In some implementations, one or more of the factors evaluated to determine whether two subscribers should be identified as neighbors can be weighted, e.g. in accordance with the factor's respect importance. For instance, two subscribers having nearly identical musical tastes can be identifies as neighbors even though they are geographically distant. Further, one or more factors can serve as thresholds. For instance, a particular geographical proximity, e.g. less than 500 miles, can be required to designate two subscribers as neighbors.

The GetSocial interface 1902 can include a banner 1904 showing images representing some or all of the subscriber's friends and/or neighbors. In some implementations, banner 1904 can be scrollable, e.g. in response to touch input. Additionally, in some implementations, the media application can communicate with one or more contacts databases maintained on the mobile communications device, e.g. through an API, to identify contacts who can be added as friends if they also are subscribers, to add contact entries corresponding to individuals identified as friends, or both.

GetSocial interface 1902 also can include a search button 1906, which can be used to access a search tool. The search tool can be used to search, e.g. through one or more keywords, for individuals, e.g. friends, neighbors, or contacts. A listing of friends and neighbors also can be accessed directly. For instance, MyFriends button 1908 can be actuated to show all of the individuals the subscriber has designated as friends, e.g. in friends interface 1916. Also, MyNeighbors button 1910 can be actuated to show all of the individuals who have been designated, e.g. by the media service, as neighbors of the subscriber. Further, MyProfile button 1912 can be actuated to present a profile interface, through which aspects of the subscriber's profile can be accessed, such as the subscriber's music, shout message board, friends, and neighbors. Additionally, a MyShoutBox button 1914 can be included to provide direct access to messages (shouts) received through the media service. In some implementations, the MyShoutBox button 1914 can be presented only when new messages are in the message box.

Friends interface 1916 can include images representing others the subscriber has designated as friends. The images can be photos, avatars, or other representative images. Also, a text identifier, e.g. a user name or screen name, can be associated with the image and can be persistently displayed or presented based on interface input, such as the positioning of a cursor. Further, an image can be selected through interface input to access an interface of the corresponding friend. For instance, selecting friend image 1918 representing Mike Essel can cause the profile interface 1920 for that friend to be presented.

The profile interface 1920 can include a match identifier 1922, indicating the degree of commonality between the subscriber's local media archive and the friend's local media archive. Also, the most recent public message posted by the friend can be presented in a Shout bubble 1924. A scrollable banner 1926 showing friends and/or neighbors of the accessed friend also can be presented, along with buttons to access public areas of the friends profile, including music 1928, Shout board 1930, friends 1932, and neighbors 1934. Additionally, one or more command buttons can be included in profile interface 1920 to permit interaction with or about the friend, including SendShout button 1936 to send a message to the friend, RemoveFromFriends button 1938 to remove the friend from the subscriber's list of friends, and ReportUser button 1940 to report the friend to the media service.

FIG. 19B shows an exemplary music interface 1942, which can be presented in response to actuating the music button 1928. The music interface 1942 can present multiple categories of the friend's local music archive, which can be explored. For instance, the music interface 1942 can include options to access the friend's top songs 1944, playlists 1946, ringback tones 1948, and ringtones 1950. Further, the music interface 1942 can include one or more options for comparing the subscriber's local media archive with that of the friend. For instance, the Exclusive Songs category 1952 can be accessed to present an Exclusive Songs interface 1958 showing a listing of songs that are included in the friend's local media archive but not in the subscriber's local media archive. In contrast, the category My Exclusive Songs 1954 can be accessed to show a listing of songs that are exclusive to the subscriber's local media archive, e.g. which can be recommended through a Shout message. Additionally, the category Our Common Songs 1956 can be accessed to show a listing of songs appearing in the local media archive of both the subscriber and the friend.

The Exclusive Songs interface 1958 also can include features and commands to permit the subscriber to perform operations relating to the list of songs. For instance, a subscribe button 1960 can be actuated to subscribe to the friend's exclusive tracks. Also, one or more tracks can be selected from the listing and operated on using the download button 1962, the playlist button 1964, the shout button 1966, and the suggest button 1968. With the exception of downloading and subscribing, similar operations can be performed in interfaces corresponding to the subscriber's exclusive tracks and common tracks.

Unlimited Media Content System

The described unlimited media content system is an access based service that bundles media content, such as music into a wireless rate plan for one flat monthly rate, the service can includes unlimited talk, unlimited text and picture messaging, unlimited data and web browsing, unlimited ringtones, unlimited ring back tones and unlimited full track downloads and other premium data services such as mobile video, mobile email and data backup. Subscribers to the unlimited media content service can be served through the subscriber's device (e.g., mobile handset) application and a web management interface. All full track downloads are transferred to, and only to, the phone over-the-air and reside on a secure encrypted ‘Trusted Flash’ SD Card partition. The full tracks are only accessible if the subscriber has paid their monthly wireless bill for the month. If a user does not pay their bill, then all of the music products are no longer accessible and are locked on the SD Card, in addition to the other features of the plan like voice, messaging and data. Preview clips are available on the handset application and through the web management interface. Preview clips on the web management interface are streamed to a secure flash player and are available to unlimited media content service subscribers only.

The service incorporates a social networking component with shared playlists and ‘Shout’ messages to ‘Friends’ and ‘Neighbors’. It also includes discovery tools such a pre-programmed playlists, a song id application and recommendation functions.

The described unlimited media content service can be implemented as a conditional download store. Subscribers may download full tracks while, and only while, they have a valid subscription. Subscribers may browse/search the music store from the handset application or the web interface. Subscribers may also receive track and playlist recommendations from ‘Friends’ and ‘Neighbors.’ Playlists from Celebrities and guest DJs can also be available. All tracks are downloaded over the air (OTA) to the secure encrypted ‘Trusted Flash’ SD Card partition and are accessible only through media content application on the phone.

Subscribers can discover and access media content items through several means: including

1) The Get Music—The mobile equivalent of a music store. Designed and optimized specifically for data input and music discovery on a small device with a small screen.

2) My DJ—Users can subscribe to pushed playlists compiled thematically by style, genres, guest artists/celebrities, label marketing . . . many options.

3) Friends/Neighbors—Users can subscribe to the public playlists of other ‘Friends/Neighbors’ subscribers.

4) Shouts—A shout is a communication between two users of the mobile music service. Most shouts are viewable by all, showing up in public feeds. Users have the option of making a shout private, in which case only the recipients receive the communication. A Shout can be (or contain) a pointer to a song, an album, an artist or a playlist.

Subscribers can download music simply by clicking the download icon associated with a track, album, artist or playlist.

Subscriptions are authorized, allocated and de-allocated directly by Cricket CRM. On allocation the Handset is given the terminal date for said allocation and the subscriber may play full tracks until that date. Network operations, such as browsing new music, require the daily generation of an encrypted token created between the Cloud, the unique phone ID and the unique card ID. If a user's subscription runs out, the media content application will not receive an authorization from Cricket CRM and will not run. The user is ‘Hot Lined’ by Cricket and messaged to renew their subscription. The user's audio files remain secure, encrypted and locked, on the SD Card.

The described unlimited media content delivery system can have various components. A Management Web Server can host the management web site that allows WMG to monitor the import and encoding process. A Persistent Content Storage can persist the original media files from the labels. An Intelligent Content AI can take input from a variety of systems and synthesizes a vast number of both general and personalized content libraries for the purposes of delivering an ever-evolving array of playlists to the handset. The Intelligent Content AI can create meaningful and up-to-date programming from seeds as small as a genre/style or single artist.

A Distributed Recommendation Engine performs all of the complicated calculations to create a collection of recommendations for both items and users. It collects user behavior and periodically re-populates the data in the Recommendation and Correlation Rendering module after performing its calculations. The computations are very intensive and time consuming for they ultimately end up aggregating and comparing each and every user with each and every piece of content. This is why the service performs the calculations in the background and then writes them to the consumer and ancillary service facing module.

A Recommendation and Correlation Rendering system can take the ratings from the Collaborative Filter and makes them available in a robust and responsive service for the client as well as the various other services in the platform. It can use the back-end computation of the Collaborative Filter and focuses solely on caching and making available the correlations that were generated. This ensures platform responsiveness and availability while performing complex operations. Its primary outward facing methods perform two functions: first, it takes any number of pieces of content and returns the statistically most related content (based on consumer taste). Secondly, it can take any user or collection of users and return a list of that user's “taste neighbors;” people who share the most musical preferences in common. Each recommendation has a particular weight associated with it to indicate its relative importance.

An External Social Gateway can extend the social activities that happen on the unlimited music service system to other platforms on the internet. For example, a subscriber can direct his/her “friends and neighbors” Shouts to also populate their Twitter and Facebook status updates. This can be done by having the subscriber go to the web management tool and authorize this application to communicate with the third-party partners (through their published APIs).

A Media Storage and Delivery system can provide subscribers with secure and unfettered access to content. It will transmit content to only authenticated Cricket customers who are currently subscribing to the unlimited media content service (as verified by the Authorization and Validation component). The files themselves will be transmitted over the air using a strong HTTPS connection so that the transmission itself is not vulnerable to interception. Finally, the web host for these files will support the HTTP 1.1 protocol which will allow the client's download agent to pause and resume downloads at will. The service will also provide 30 second samples of a file for preview purposes.

An Authorization and Validation services can form the gateway between the subscriber's handset, the web application and the content provided by the service. This module has a persistent connection with the server's back-end to keep an up-to-the-second eye on a given consumer's subscription status with the unlimited media content delivery system. It can use this knowledge to not only authorize or deny client to server transactions but to also inform the client on whether the downloaded content (ringtones and music) should be accessible. It also communicates to the Ringback Tone Management Gateway to enable/disable a consumer's ringback tones based on their status.

When a device is performing a sync operation, it is having a prioritized, interactive conversation with this module to identify the differences between the catalog contained on the handset and the catalog that the central database has for this user. Once the differences are identified between the two, a prioritized list of content is delivered to the client for download. The system is smart enough to know about content that has been downloaded but may be present on a separate memory card.

For the web management portion of the architecture, the browser application is merely making changes to the metadata stored in the database in order to trigger device synchronization.

A Web Management Application can use a web application that allows for remote browsing and management as well as a small utility that can be downloaded and executed from the site that scans the consumer's hard drive to identify and automatically include that content in the consumer's library. It can be operated from any computer, any browser and in any geographical location due to the fact that it performs all of its synchronization through the platform's cloud services.

Each card has a unique identifier (i.e. Logical Device ID, LDID) that can be read only by the SanDisk Host SDK. The card is preconfigured with a fixed-size public partition, and a fixed-size “hidden” partition. Content stored in the hidden partition can be read only by authorized applications and only after authentication. The card is preconfigured with an authentication account for access to the hidden partition. Hidden partition contents are ciphered by the card with a card unique key. Ciphering is done on-the-fly as the content is written to the partition. AES encryption with 128 bit keys and ECB mode will be used for encryption.

The account login operation uses as credentials 128-bit card unique keys, with symmetric one way authentication using AES. The SanDisk Host SDK will be authenticated by the card using the credential provided by the media content application. Once logged in, the Host SDK will only give access to authorized applications. Credentials are generated by the server using a SanDisk key generation function. The function takes card LDID as its input and generates a key that is suitable for the login process (128-bit key) and is unique per card. The function is developed by SanDisk and provided only to Wilshire for integration into the server application. The function is also used by SanDisk production when the card account is created. The function is part of the server implementation. No other software component contains the function.

The Host SDK will establish an open session with the card after the login. Content will be transferred over the SD bus in the clear and ciphered/de-ciphered by the card. The Host SDK will use a challenge and response mechanism to identify authorized applications. Challenge-response functions will be provided by SanDisk only to Wilshire for integration into their applications.

The authentication process between the Host SDK and the application will result in an authentication id being generated by the Host SDK and communicated to the application. The authentication id is valid until next handset power cycle. Wilshire applications will append this information to the file names when accessing content.

Users are authenticated by their account through server CRM. Users must have a valid up to date subscription to access the unlimited media content delivery service to download and play tracks and tones.

Applications of Secure Media Content Deliver System

A Media Storage and Delivery system can provide subscribers with secure access to their media content. Media content items are transmitted to only authenticated subscribers with active subscription (e.g., Unlimited Music subscriptions), which can be verified by a Authorization and Validation component. The files for the media content items can be transmitted over the air using a strong HTTPS connection so that the transmission itself is not vulnerable to interception. In addition, the web host for these files can support applicable communication protocols, such as the HTTP 1.1 protocol which allows the subscriber's download agent to pause and resume downloads at will. The service can also provide 30 second samples of a file for preview purposes.

A sync management system can be implemented to handle synchronization of subscriber device database with the central database at the server-side. When changes to the subscriber's account or playlists are made on the server, the sync management system can sync the database on the subscriber's device to be consistent with the changes made at the server. These synchronizations are initiated with calls from the handset to server-based web services, and can also be sent down the handset via SMS when the handset does not have an active data connection.

Frequency of synchronization can be adjusted based on the updates to the playlists to increase or decrease the rate of sync for freshness, burn and play count. Playlists that are updated more often can be synchronized more frequently, and playlists that are less-frequently played are lower priority and can be synchronized less often.

To implement community aspects of the Unlimited Music System, such as GetSocial, a contacts system can be implemented to manage and store contact information for the subscribers. The system can periodically query for changes to the user's contact list. The queries can be for name, phone number and image in order to automatically populate the subscriber's “friends” tab with their contacts by looking up their numbers at the server. In some implementations, a contact management system can be implemented to allow subscribers to automatically import their friends' Unlimited Music account avatars to update those friends' contact records.

A data service system can be implemented to maintain a local database of the media content items (e.g., music) that a subscriber has downloaded to his/her device. The system can also store playlist programming, play counts and their reporting status, play history data, local cache contents and status, content-level sync state, and other relevant metadata such as album art.

This data service system can be storage-independent since subscribers may have multiple account access cards (e.g., inserted into subscriber device) for use with their Unlimited Music account. To account for multiple cards, a device identifier can be used to display and search the metadata that exists on currently inserted card. Also, a record of content that was specifically downloaded by the user can be maintained rather than the content that was placed on the device as a part of a push. This data service system can maintain the available local content store for all activities (including browsing, playing, downloading, sequencing, licensing and synchronizing).

A content rendering system can process local and remote data sources and a library of local display templates to create the music management application interface on the subscriber's mobile device. The content rendering system can manage user interactions including: browsing and managing local content, browsing and acquiring remote content, browsing the community, subscribing to playlists, receiving and sending Shouts, and managing the service's settings.

A content download managing system can be implemented to handles all of the content download requests that are generated through either user interaction or routine synchronization with the cloud servers. The managing system can actively be aware of the local playback queue and actively prioritizing content that needs to be played back progressively even while downloading a different track. The managing system can also be aware of the network demands and connectivity status of the handset and is able to pause synchronization should the user perform a network-heavy task like browsing the mobile web. Once the traffic from that alternate session subsides, the download manager ramps back up its data throughput until another competing request is made.

A music sequencing engine can be implemented on the subscriber device to use subscriber's play history to algorithmically sequence music to allow maximum diversity while maintaining a keen understanding of its freshness. By using the subscriber's past play history, repetitive or otherwise unsatisfactory listening experiences can be reduced or eliminated. Additionally, when playing through a collection of content in a shuffle mode, the ideal play repetition may be a shuffle based on diversity rather than a simple random song selection. The music sequencing engine takes on-device shuffle beyond the simple randomization of tracks and create a unique and compelling radio-like experience from the content stored on the device, without reliance on a server-based music scheduling component.

Dynamic music sequencing can use the knowledge of the user's play history, not merely for tracks, but also for individual object-oriented artists, albums, genres, and works. Additionally, super-organizing entities that represent the song as a composition and not as a performance allow the sequencing engine to recognize and “understand” cover versions of content.

A network I/O system can provide wireless data services on the handset, allowing the service to request content from the various servers that comprise the “cloud” portion of the service. The network I/O system can provide feedback regarding its multitasked usage so that the download manager can be as efficient as possible with its bandwidth usage. For example, with handsets where simultaneous bandwidth-utilizing activities are limited, background download operations may be suspended while the user is attempting to have a mobile web experience.

The media content that are ‘Now Playing’ can be managed by a separate content rendering manager to allow for control of the listening experience using a smaller, less complicated application, resulting in better overall device performance.

A shout services system can be implemented to handle all of the management tasks related to sending and receiving multimedia Shouts from the subscriber's device. Using both the network services layer and the device's SMS services, the availability of Shouts can be monitored and can signal to the UI when new messages are available. In addition, contextual information to the phone's main menu screen can be implemented for a direct-to-Shout link, indicating the number of unread Shouts in the user's inbox.

There are at least two types of Shouts in the system: a friend/direct Shout and a nearby Shout. Friend/direct Shouts are actively polled for and downloaded to the handset. Nearby Shouts are polled at the server and a unique count is maintained, but the Shouts themselves aren't downloaded until the user elects to browse and view them. While the cloud stores all Shouts, the handset only stores the most recent Shouts in its memory. Searches for Shouts take place up in the cloud and are returned to the client.

A storage I/O system can handle the reading and writing of content to the on-board storage locations, including the phone's internal memory as well as the phone's removable MicroSD storage.

The disclosed techniques for providing subscribers with unlimited access to media content may be implemented using one or more computer programs comprising computer executable code stored on a tangible computer readable medium and executing on the data processing device or system. The computer readable medium may include a hard disk drive, a flash memory device, a random access memory device such as DRAM and SDRAM, removable storage medium such as CD-ROM and DVD-ROM, a tape, a floppy disk, a Compact Flash memory card, a secure digital (SD) memory card, or some other storage device. In some implementations, the computer executable code may include multiple portions or modules, with each portion designed to perform a specific function described in one or more figures. In some implementations, the techniques may be implemented using hardware such as a microprocessor, a microcontroller, an embedded microcontroller with internal memory, or an erasable, programmable read only memory (EPROM) encoding computer executable instructions for performing the disclosed techniques. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory, a random access memory, or both. The elements of a computer include a processor for executing instructions and one or more memory devices for storing instructions and data. Generally, a computer will also include, or be operatively coupled to receive data from or transfer data to, or both, one or more mass storage devices for storing data, e.g., magnetic disks, magneto-optical disks, and optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, the systems, apparatus, and techniques described here can be implemented on a data processing device having a display device (e.g., an LED (light emitting diode) or LCD (liquid crystal display) monitor) for displaying information to the user and a positional input device, such as a keyboard and a pointing device (e.g., a touch screen, mouse, or trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

While this specification contains many specifics, these should not be construed as limitations on the scope of any innovation or of what may be claimed, but rather as descriptions of features that may be specific to particular embodiments of particular innovations. Certain features that are described in this specification in the context of separate embodiments also can be implemented in combination in a single embodiment. Conversely, various features that are described in the context of a single embodiment also can be implemented in multiple embodiments, either separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application, including in the attached appendix.

What is claimed is:

1. A computer-implemented method of providing access to media content, the method comprising:
transmitting a request from a mobile communications device to subscribe to a media playlist;
determining, for the mobile communications device, a local media archive inventory;
comparing the local media archive inventory with a track listing corresponding to the subscribed media playlist; and
transferring to the mobile communications device an item of media content associated with the track listing that is not included in the local media archive inventory.

2. The method of claim 1, further comprising:
receiving a media listing of available media content for playback.

3. The method of claim 2, further comprising:
presenting a user interface on the mobile communication device to receive user selection of one or more media content items in the media listing.

4. The method of claim 3, wherein the user interface includes an option to play the one or more media content items immediately.

5. The method of claim 3, wherein the user interface includes an option to play the one or more media content items after the currently playing media content item.

6. The method of claim 3, wherein the user interface includes an option to modify the contents of the media listing by adding or removing one or more media content items from the media listing.

7. The method of claim 3, wherein the user interface includes an option to generate a play list from the media listing.

8. The method of claim 7, further comprising:
receiving a user selection of one or more media content items to be added to the play list;
determining whether the user selected one or more media content items are already stored on the mobile communication device; and
automatically downloading media content items not already stored on the mobile communication device.

9. A non-transitory computer-readable medium storing instructions for causing a mobile device to perform operations for providing access to media content, the operations comprising:
transmitting a request from a mobile communications device to subscribe to a media playlist;
determining, for the mobile communications device, a local media archive inventory;
comparing the local media archive inventory with a track listing corresponding to the subscribed media playlist; and
transferring to the mobile communications device an item of media content associated with the track listing that is not included in the local media archive inventory.

10. The non-transitory computer readable medium of claim 9, wherein the operations further comprises:
receiving a media listing of available media content for playback.

11. The non-transitory computer readable medium of claim 10, wherein the operations further comprises:
presenting a user interface on the mobile communication device to receive user selection of one or more media content items in the media listing.

12. The non-transitory computer readable medium of claim 11, wherein the user interface includes an option to play the one or more media content items immediately.

13. The non-transitory computer readable medium of claim 11, wherein the user interface includes an option to play the one or more media content items after the currently playing media content item.

14. The non-transitory computer readable medium of claim 11, wherein the user interface includes an option to modify the contents of the media listing by adding or removing one or more media content items from the media listing.

15. The non-transitory computer readable medium of claim 11, wherein the user interface includes an option to generate a play list from the media listing.

16. The non-transitory computer readable medium of claim 15, wherein the operations further comprises:
receiving a user selection of one or more media content items to be added to the play list;
determining whether the user selected one or more media content items are already stored on the mobile communication device; and
automatically downloading media content items not already stored on the mobile communication device.

17. A mobile communication device for providing access to media content, the mobile device comprises:
a transmitter configured to transmit a request to subscribe to a media playlist;
a baseband processor in communication with the transmitter to determine, for the mobile communications device, a local media archive inventory;
the baseband processor comparing the local media archive inventory with a track listing corresponding to the subscribed media playlist; and
the baseband processor instructing a receiver to download to the mobile communications device an item of media content associated with the track listing that is not included in the local media archive inventory.

18. The mobile communications device of claim 17, wherein the baseband processor is configured to:
receiving a media listing of available media content for playback.

19. The mobile communication device of claim 18, further comprising a display unit configured to:
present a user interface on the mobile communication device to receive user selection of one or more media content items in the media listing.

20. The mobile communications device of claim 19, wherein the user interface includes an option to play the one or more media content items immediately.

21. The mobile communications device of claim 19, wherein the user interface includes an option to play the one or more media content items after the currently playing media content item.

22. The mobile communications device of claim 19, wherein the user interface includes an option to modify the contents of the media listing by adding or removing one or more media content items from the media listing.

23. The mobile communications device of claim 19, wherein the user interface includes an option to generate a play list from the media listing.

24. The mobile communications device of claim 15, wherein the baseband processor is configured to:
receive a user selection of one or more media content items to be added to the play list;
determine whether the user selected one or more media content items are already stored on the mobile communication device; and
automatically download media content items not already stored on the mobile communication device.
